(19) United States
(12) Patent Application Publication
(10) Pub. No.: US 2021/0267412 A1
(43) Pub. Date: Sep. 2, 2021

(54) ANTI-ODOR COVER

(71) Applicants: ETHERA, Crolles (FR); COMMISSARIAT À L'ÉNERGIE ATOMIQUE ET AUX ÉNERGIES ALTERNATIVES (CEA), Paris (FR); CENTRE NATIONAL DE LA RECHERCHE SCIENTIFIQUE, Paris (FR)

(72) Inventors: Marie-Pierre SOM, Crolles (FR); Thu-Hoa TRAN-THI, Montrouge (FR); Christophe THERON, Villeneuve-les-Maguelone (FR); William BAMOGO, Le Pecq (FR); Trung-Hieu NGUYEN, Fontenay-aux-Roses (FR)

(73) Assignees: ETHERA, Crolles (FR); COMMISSARIAT À L'ÉNERGIE ATOMIQUE ET AUX ÉNERGIES ALTERNATIVES (CEA), Paris (FR); CENTRE NATIONAL DE LA RECHERCHE SCIENTIFIQUE, Paris (FR)

(21) Appl. No.: 17/257,988

(22) PCT Filed: Jul. 12, 2019
(86) PCT No.: PCT/FR2019/051752

§ 371 Date: Jan. 5, 2021

(30) Foreign Application Priority Data
Jul. 12, 2018 (FR) 1856413

(51) Int. Cl. A47J 36/06; A47J 36/02; B01J 20/28; B01J 20/20; B01J 20/32

(52) U.S. Cl. CPC A47J 36/06; A47J 36/02; B01J 20/28007; B01J 20/3272; B01J 20/20; B01J 20/3204; B01J 20/3293; B01J 20/28019

(57) ABSTRACT

Air filtration, in particular in cooking appliances, such as for example deep fryers. In particular, an odorless lid suitable for any container that allows odors or volatile compounds to escape and more particularly for any food cooking appliance, the odorless lid comprises a filtering material of particles having a core-shell structure, wherein the activated carbon core is surrounded by a shell of a mesoporous sol-gel material based on functionalized or nonfunctionalized silica.

### FIELD OF INVENTION

The present invention relates to the field of air filtration, in particular in cooking appliances such as, for example, fryers or frying pans. In particular, the present invention relates to an anti-odor cover suitable for any receptacle allowing odors or volatile compounds to escape and more particularly to a food cooking appliance, said anti-odor cover comprising particles having a core-shell structure consisting of an activated charcoal core surrounded by a shell of a mesoporous silica-based sol-gel material.

### BACKGROUND OF INVENTION

Air pollution control, and in particular for pollutants such as volatile organic compounds (VOCs) via air cleaners or extractor hoods, relies primarily on the use of activated carbon-based filters. The latter indeed has a significant adsorption capacity and low cost. However, activated carbon very poorly traps the small polar molecules present in indoor air such as formaldehyde, acetaldehyde, methyl and ethyl ketones, acetic acid, acrolein or even acrylamide resulting from decomposition of superheated oil (such as fried foods).

In order to overcome this inefficient trapping of small and polar VOCs by the activated carbon, the latter is often impregnated with reagents capable of reacting with the target pollutants. However, a drawback of impregnated materials is the release into the air of the impregnation reagents or of the products resulting from their reaction.

Therefore, there is a need to provide new air filter materials combining high filtration capacity of different types of polar and nonpolar molecules of the material with a simple and efficient preparation process.

In the more specific field of food cooking appliances, manufacturers are always looking for innovative solutions to limit and/or overcome cooking odors, in particular frying odors.

Surprisingly, the Applicant has demonstrated that particles having a core-shell structure in which the core is activated carbon and the shell comprises sol-gel silica, functionalized or not, make it possible to effectively trap cooking vapors, and in particular frying. Advantageously, the Applicant provides a filter material that is more efficient than activated carbon and a simple and efficient process for preparing this material.

### SUMMARY

The present invention therefore relates to an anti-odor cover, preferably for a cooking appliance, said anti-odor cover comprising an upper wall and a lower wall characterized in that the lower wall comprises a filter material comprising core-shell particles consisting of ‘a core of activated carbon surrounded by a shell of mesoporous sol-gel silica.

According to one embodiment, the core-shell particles are spherical and have a diameter of 20 to 400 nm.

According to one embodiment, the mesoporous sol-gel silica shell comprises a siloxane formed from at least one organosilicon precursor chosen from tetramethoxysilane (TMIOS), tetraethoxysilane (TEOS), phenyltrimethoxysilane (PhTMOS), phenyltriethoxysilane (PhTEOS), (2-phenylethyl)triethoxysilane, 3-aminopropyltriethoxysilane (APTES), (3-glycidyloxypropyl)trimethoxysilane (GPTMOS), (3-glycidyloxypropyl)triethyoxysilane (GPTES), N-(2-aminoethyl)-3-(trimethoxysilyl)propylamine (NH₂-TMOS), N-(trimethoxysilylpropyl) ethylenediaminetriacetate, acetoxyethyltrimethoxysilane (AETMS), ureidopropyltriethoxysilane (UPTS), 3-(4-semicarbazidyl)propyltriethoxysilane (SCPTS) and mixtures thereof; preferably the organosilicon precursor is tetramethoxysilane or tetraethoxysilane.

According to one embodiment, the organosilicate precursor is a mixture of tetramethoxysilane and a functionalized organosilicate precursor, advantageously chosen from phenyltrimethoxysilane (PhTMOS), phenyltriethoxysilane (PhTEOS), (2-phenylethyl)triethoxysilane. 3-aminopropyltriethoxysilane (APTES), (3-glycidyloxypropyl) trimethoxysilane (GPTMOS), (3-glycidyloxypropyl) triethoxysilane (GPTES), N-(2-Aminoethyl)-3-(trimethoxysilyl) propylamine (NH₂-TMOS), the N-(Trimethoxysilylpropyl)ethylenediaminetriacetate, acetoxyethyltrimethoxysilane (AETMS), ureidopropyltriethoxysilane (UPTS), 3-(4-semicarbazidyl) propyltriethoxysilane (SCPTS) and mixtures thereof.

According to one embodiment, the activated carbon is in the form of sticks of millimeter size.

According to one embodiment, the lower wall comprises a housing in which the filter material is arranged.

According to one embodiment, the upper wall comprises at least one exhaust opening communicating with the housing of the lower wall comprising the filter material.

According to one embodiment, the anti-odor cover further comprises a window.

The present invention also relates to a food cooking appliance comprising an anti-odor cover as described above.

According to one embodiment, the food cooking appliance comprises a cooking bath tank; preferably the food cooking appliance is a fryer.

### Definitions

In the present invention, the terms below are defined as follows:
“Lid” refers to a moving part that adapts to the opening of a container to close it.
“Anti-odor” refers to a material or element capable of partially or totally trapping odors, preferably from cooking.
“Cooking appliance” relates to any receptacle suitable for cooking food. According to one embodiment, the cooking apparatus is a saucepan, a frying pan, a pressure cooker or a deep fryer.
“Filter material” refers to any material capable of filtering a quantity or a flow of air.

### DETAILED DESCRIPTION

Process

The present invention relates to a process for preparing a filter material, preferably an odor-resistant material.

According to one embodiment, the present invention relates to a process for preparing a core-shell hybrid material consisting of an activated carbon core surrounded by a shell of a mesoporous silica-based sol-gel material, said A process comprising forming a shell of mesoporous sol-gel silica around activated carbon particles and recovering the core-shell hybrid material thus obtained.

A sol gel material is a material obtained by a sol-gel process consisting in using as precursors metal alkoxides of formula M(OR)xR′n-x in which M is a metal, in particular silicon, R an alkyl group and R′ a group carrying one or more functions with n=4 and x which can vary between 2 and 4. In the presence of water, the alkoxy groups (OR) are hydrolyzed into silanol groups (Si—OH). The latter condense to form siloxane bonds (Si—O—Si—). When the silica precursors in low concentration in an organic solvent are added dropwise in a basic aqueous solution, particles of size generally less than 1 μm are formed, which remain in suspension without precipitating. Depending on the synthesis conditions, it is possible to obtain monodisperse or polydisperse nanoparticles, spherical in shape, and whose diameters can vary between a few nanometers to 2 μm. The porosity of silica nanoparticles (microporosity or mesoporosity) can be varied by adding a surfactant.

In the present invention, the mesoporous sol-gel silica shell is formed from at least one organosilicon precursor. It is thus possible to use a single organosilicon precursor or a mixture of organosilicon precursors. The at least one organosilicon precursor is advantageously chosen from tetramethoxysilane (TMOS), tetraethoxysilane (TEOS), phenyltrimethoxysilane (PhTMOS), phenyltriethoxysilane (PhTEOS), (2-phenylethyl) triethoxysilane, 3-aminopropyltriethoxysilane (APTES), (3-glycidyloxypropyl) trimethoxysilane (GPTMOS), (3-glycidyloxypropyl) triethoxysilane (GPTES), N-(2-Aminoethyl)-3-(trimethoxysilyl) propylamine (NH₂-TMOS), N-(Trimethoxysilylpropyl) ethylenediaminetriacetate, G acetoxyethyltrimethoxysilane (AETMS), Tureidopropyltriethoxysilane (UPTS), 3-(4-semicarbazidyljpropyltriethoxysilane (SCPTS) and their mixtures (tetramethosilostrimethosilane (TMOS), tetraethoxysilane (TEOS), phenyltrimethoxysilane (PhTMOS), phenyltriethoxysilane (PhTEOS), (3-glycidyloxypropyl) triethoxysilane (GPTES), N-(2-Aminoethyl)-3-(trimethoxysilyl) propylamme (NH₂-TMOS), 3-ammopropyltriethoxysilane (APTES), N-(Trimethoxysilylpropyl) ethylenediaminetriacetate, acetoxyethyltrimethoxysilane (AETMS), 3-(4 semiearhazidyljpropyltriethoxysilane (SCPTS) and mixtures thereof.

According to one embodiment, the organosilicon precursor is tetraethoxysilane or tetramethoxysilane, preferably tetraethoxysilane. In another embodiment, the organosilicon precursor is a mixture of tetramethoxysilane or tetramethoxysilane and a functionalized organosilicon precursor. Advantageously, these are amine, amine, urea, acid or aryl functions. The functionalized organosilicon precursor can in particular be chosen from phenyltrimethoxysilane (PhTMOS), phenyltriethoxysilane (PhTEOS), (2-phenylethyl) trietboxysilane, 3-aminopropyltriethoxysilane (APTES), (3-giycidyloxysilane) (GPTMOS), (3-glycidyloxypropyl) triethoxysilane (GPTES), N-(2-Aminoethyl)-3-(trimethoxysilyl) propylamine (NH₂-TMOS), N-(5 (Trimethoxysilylpropyr) ethylenediaminetriacetate, 1′ acetoxyethyltrimethoxysilane (AETMS), ruréidopropyltriethoxysilane (UPTS), 3-(4-semicarbazidyl) propyltriethoxysilane (SCPTS) and their mixtures, preferably from among phenyltrimethoxysilane (PhTMOS), phenyltriethoxysilane (PhTEOS) (3-glycidyloxypropyl)triethoxysilane (GPTES), la N-(2-Aminoethyl)-3-(trimethoxysilyl)propylamine (NH₂-TMOS), 3-aminopropyltrethoxysilane (APTES), N-(Trimethoxysilylpropyl) ethylenediaminetriacetate, acetoxyethyltrimethoxysÏlane (AETMS) 3-(4-semicarbazidyl) propyltriethoxysilane (SCPTS) and mixtures thereof.

Mixtures of preferred organosilicon precursors include mixtures of tetraethoxysilane (TEOS) with N-(2-Aminoethyl)-3-(trimethoxysilyl) propylamine (NH₂-TMOS), with N-(Trimethoxysilylpropyl) ethylenediaminetriacetate, with phenyltrimethoxysilane (PhTMOS) and with 3-(4-semicarbazidyl) propyltriethoxysilane (SCPTS) as well as mixtures of tetramethoxysilane (TMOS) with 3-ammopropyltriethylioxysilane (APTES), with phenyltrimethoxysilane (PhTMOS) with phenyltriethoxysilane (PhTMOS), with acetoxyethy Itrimethoxysilane (AETMS), with (3-glycidyloxypropyl) triethoxysilane (GPTES) and with 3-(4-semicarbazidyl) propyltriethoxysilane (SCPTS).

According to one embodiment, when using a mixture of tetramethoxysilane and one or more other organosilicon precursors, the molar proportions of tetramethoxysilane (TMOS)/other organosilicon precursor(s) can be varied between 100/0 and 50/50, preferably between 100/0 and 75/25, more preferably between 97/3 and 75/25 or between 98/2 and 89/11.

According to one embodiment, the activated carbon used for the present invention can be of plant or animal origin. Those skilled in the art will choose it according to the desired properties, in particular filtration. Thus, it is possible to use different forms of activated charcoal, such as beads, powder, granules, fibers or sticks. Preferably, an activated carbon with a large specific adsorption surface area will be used, in particular from 800 to 1500 m²/g. The activated carbon can be mixed at different concentrations with the coating composition (sol-gel composition) to modulate the amount of core/shell.

According to one embodiment, the method of the invention is characterized in that the formation of a shell of mesoporous sol-gel silica around the activated carbon particles comprises:
a) the formation of a shell of sol-gel nanoparticles around of activated carbon particles in basic aqueous solution from at least one organosilicon precursor, the aqueous solution containing ammonia (NH₄OH) and a surfactant,
b) recovery of the activated carbon surrounded by the shell of sol-gel material prepared in step a),
c) elimination of any surfactant residues from the activated carbon surrounded by the shell of sol-gel material to free the pores of the sol-gel material formed in step a),

and characterized in that in step a), a basic aqueous solution is first provided containing ammonia, the surfactant and the activated carbon, then the at least one organosilicon precursor is added, this precursor being dissolved in an organic solvent.

Thus, according to this embodiment, the process for preparing a core-shell hybrid material consisting of an activated carbon core surrounded by a mesoporous sol-gel silica shell comprises the following steps:
a) the formation of a shell of sol-gel nanoparticles around particles of activated carbon in basic aqueous solution from at least one organosilicon precursor, the solution aqueous containing ammonia (NH₄OH) and a surfactant,
b) recovery of the activated carbon surrounded by the shell of sol-gel silica prepared in step a),
c) removal of any surfactant residue from the carbon active surrounded by the shell of sol-gel material to free the pores of the sol-gel material formed in step a),
d) recovery of the hybrid core-shell material consisting of a core of activated carbon surrounded by a mesoporous silica sol-gel shell obtained in step c),

characterized in that in step a), a basic aqueous solution is first provided containing ammonia, the surfactant and the activated carbon, then the at least one organosilicon precursor is added, this precursor being solubilized in an organic solvent.

Surprisingly, this embodiment gives rise to discrete core-shell particles, the silica nanoparticles exhibiting low agglomeration between them. In view of the literature (see for example Rahman et al., Journal of nanomaterials, Vol. 2012), the person skilled in the art hitherto believed that it was necessary to carry out the synthesis of the sol-gel nanoparticles in an organic solvent such as ethanol for on the one hand to form monodisperse nanoparticles of small size and on the other hand to avoid the agglomeration of the nanoparticles between them. In the experiments of Journal of Colloid and Interface Science, 289 (1), 125-131, 2005 for example, the amounts of ethanol and water vary between 1 to 8 mol/L and 3 to 14 mol/L, respectively and depending on the concentration of the precursor in solution in ethanol, the authors obtain diameters of silica nanoparticles varying between 30 and 460 nm.

However, in this embodiment, the synthesis is carried out in aqueous solution and the contribution of the organic solvent for the solubilization of the organosilicon precursors is very low compared to the volume of the final sol. Advantageously, the amount of organic solvent is from 1 to 5% by volume, preferably from 1.5 to 4% by volume and more preferably still from 1.8 to 3% by volume relative to the final sol (i.e. the whole aqueous solution containing the ammonia, the surfactant and the activated carbon plus the organosilicon precursor dissolved in the organic solvent). Advantageously, the basic aqueous solution provided in step a) is free from organic solvent and the organic solvent is only provided with the organosilicon precursors. Without wishing to be bound by any theory, the inventors believe that it is the sequence of addition of the various reagents which makes it possible to prevent agglomeration of the nanoparticles despite the use of an aqueous solvent. It seems essential to add the organosilicon precursor last.

According to one embodiment, the organic solvent used to dissolve the organosilicon precursor(s) will be chosen by a person skilled in the art according to the organosilicate precursor or the mixture of organosilicon precursors used, in particular from polar, protic or aprotic organic solvents. This organic solvent can, for example, be chosen from linear C1 to C4 aliphatic alcohols, in particular methanol, ethanol and propan-1-ol. Preferably, the organic solvent is ethanol.

According to one embodiment, the organosilicon precursors and the activated carbon which can be used in this embodiment are those detailed above. Preferably, at least one organosilicate precursor is selected from tetraethoxysilane (TEOS), phenyltrimethoxysilane (PhTMOS), phenyltriethoxysilane (PhTEOS), (2-phenylethyl) triethoxysilane, 3-aminopropyltrioxypropyltriethoxysilane (APTES) (3-glycidyloxypropyl)trimethoxysilane (GPTMOS), (3-glycidyloxypropyl) triethoxysilane (GPTES), N-(2-Aminoethyl)-3-(trimétlioxysilyl)propylamine (NH2-TMOS), N-(Trirnethoxysilylpropyl)ethylenediaminetriacetate, acetoxyethyltrimethoxysilane (AETMS), ureidopropyltriethoxysilane (UPTS), 3-(4-semicarbazidyl) propyltriethoxysilane (SCPTS) and their mixtures, preferably among tetraethoxysilane (TEOS), N-(2-Aminoethyl)-3-(trimethoxysilyl)propylamine (NH2-TMOS), N-(Trimethoxysilylpropyl) ethylenediaminetriacetate, phenyltrimethoxysilane (PhTMOS), 3-(4-semicarbazidyl) propyltriethoxysilane (SCPTS) and their mixtures. When using a mixture of tetraethoxysilane and a functionalized organosily precursor, the following mixtures are preferred: tetraethoxysilane with N-(2-Aminoethyl)-3-(trimethoxysilyl) propylamine (NH2-TMOS), with N-(Trimethoxysilylpropyl) ethylenediaminetriacetate, with phenyltrimethoxysilane (PhTMOS) and with 3-(4-semicarbazidyl) propyltriethoxysilane. The activated carbon is preferably in powder form, in particular of micrometric size.

According to one embodiment, when using a mixture of tetramethoxysilane or tetraethoxysilane, preferably tetraethoxysilane, and one or more functionalized organosilicate precursors, the molar proportions of tetramethoxysilane (TMOS) or tetraethoxysilane (TEOS)/other organosilicon precursor(s) can be varied between 100/0 and 50/50, preferably between 100/0 and 75/25, more preferably between 97/3 and 75/25 or between 98/2 and 89/11.

According to one embodiment, the basic aqueous solution used in step a) is preferably an aqueous ammonia solution at a concentration of 0.8 to 3.2 mol/L, preferably of 2.0 to 2.3 mol/L.

According to one embodiment, the basic aqueous solution used in step a) may contain a small amount of organic solvent, in particular polar, protic or aprotic. This organic solvent can, for example, be chosen from linear C1 to C4 aliphatic alcohols, in particular methanol, ethanol and propan-1-ol. Preferably, the organic solvent is ethanol. Preferably, the content of organic solvent does not exceed 5% by volume. More preferably, the basic aqueous solution is free from organic solvent.

According to one embodiment, the role of the surfactant used during step a) of the first embodiment is on the one hand to promote the interaction between the surface of the activated carbon and the precursors if licit and on the other starts with structuring the silica network to make it mesoporous. The surfactant used in step a) is preferably an ionic surfactant, more preferably a quaternary ammonium compound. This quaternary ammonium compound is advantageously a cetyltrimethyl ammonium halide, preferably cetyltrimethylammonium bromide or cetyltrimethylammonium chloride, more preferably cetyltrimethylammonium bromide.

According to one embodiment, the recovery of the core-shell material of activated carbon surrounded by the shell of sol-gel material in step b) of the first embodiment can for example be carried out by separation, by any known means and in particular by centrifugation or filtration, of the mixture obtained during step a). Preferably, the core-shell material is recovered by centrifugation in the first method.

According to one embodiment, the removal of any surfactant residues present in the core-shell material in step c) can be carried out by any known means and in particular by washing, for example with hydrochloric acid and the ethanol, preferably by a succession of washes with hydrochloric acid and ethanol.

According to one embodiment, the recovery of the core-shell material of activated carbon surrounded by the shell of sol-gel material in step b) can for example be carried out by separation, by any known means and in particular by centrifugation or filtration, of the mixture obtained during step a). Preferably, the core-shell material is recovered by centrifugation. Removal of the surfactant frees the pores of the material obtained in step b. Therefore, after this elimination step, the hybrid core-shell material is obtained, consisting of an activated carbon core surrounded by a shell of mesoporous silica-based sol-gel nanoparticles.

This hybrid core-shell material is recovered in step d). This recovery can for example be carried out by separation, by any known means and in particular by centrifugation or filtration, of the mixture obtained during step a). Preferably, the hybrid core-shell material is recovered by centrifugation.

In a second embodiment, the method of the invention is characterized in that step a) for forming the mesoporous sol-gel silica shell comprises the preparation of a mixture sol of at least one organosilicon precursor in an aqueous solution containing an organic solvent followed by coating the activated carbon with this sol. A thin film of mesoporous sol-gel silica is thus formed, preferably functionalized, around the particles of activated carbon. Preferably, the sol is free of surfactant.

The organic solvent is preferably a polar, protic or aprotic organic solvent. It can, for example, be chosen from linear aliphatic alcohols (C1 to C4), in particular methanol, ethanol and propan-1-ol. Preferably, the organic solvent is methanol. The volume proportion of the organic solvent relative to the volume of the soil can vary between 30 to 50%. The volume ratio of water to the volume of the soil can vary between 15 and 30%.

The organosiliated precursors and the activated carbon that can be used in this embodiment are those detailed above with respect to the process according to the invention in general. Preferably, the at least one organosilicon precursor is chosen from tetramethoxysilane (TMOS), phenyltrimethoxysilane (PhTMOS), phenyltriethoxysilane (PhTEOS), (2-phenylethyl)triethoxysilane, 3-aminopropyltriethoxysilane (APTES) 3-(glycidyloxypropyl) trimethoxysilane (GPTMOS), (3-glycidyloxypropyl) triethoxysilane (GPTES), N-(2-Aminoéthyl)-3-(trimethoxysilyl)propylamine (NH2-TMOS), N-(Trimethoxysilylpropyl)ethylenediaminetriacetate, acetoxyethyitrimethoxysilane (AETMS), ureidopropyltriethoxysilane (UPTS), 3-(4-semicarbazidyl) propyltriethoxysilane (SCPTS) and their mixtures, most preferably among tetramethoxysilane (TMOS), 3-aminopropyltriethoxysilane (APTES), phenyltrimethoxysilane (PhTMOS), phenyltriethoxysilane (PhTEOS), acetoxyethyltrimethoxysilane (AETMS), (3-glycidyloxypropyl) triethoxysilane (GPTES) and 3-(4-semicarbazidyl)propyltriethoxysilane) (SCPTS). When using a mixture of tetramethoxysilane and a functionalized organosilicon precursor, the following mixtures are preferred: tetramethoxysilane (TMOS) with 3-aminopropyltriethoxysilane (APTES), with phenyltrimethoxysilane (PhTMOS), with phenyltriethoxysilane (PhTEOS) with acetoxyethyltrimethoxysilane (AETMS), with (3-glycidyloxypropyl) triethoxysilane (GPTES) and with 3-(4-semicarbazidyl) propyltriethoxysilane (SCPTS).

When using a mixture of tetramethoxysilane and one or more functionalized organosilicate precursors, the molar proportions of tetramethoxysilane (TMOS)/other organosilicon precursor(s) can be varied between 100/0 and 50/50, preferably between 100/0 and 75/25, more preferably between 97/3 and 75/25.

According to a first variant of this second embodiment, the activated carbon is in the form of particles, in particular granules or sticks, of millimeter size and the coating is carried out by soaking them in the soil and then removing the soil or soil pouring over the particles through a sieve. The core-shell particles thus obtained are advantageously dried, for example in an oven, to remove the residual solvents. Preferably, activated carbon sticks will be used, in particular of millimeter size. In particular, the casting method will be favored to form a thin film of functionalized sol-gel material around the activated carbon core. This rapid process is easily transposed to an industrial scale and is well suited to activated carbon in granules or sticks.

According to a second variant of this second embodiment, the activated carbon is in the form of a powder and the coating is carried out by adding the activated carbon powder to the soil, then the mixture obtained is poured into molds. The molds thus filled are advantageously dried under an inert gas flow to remove the residual solvents before removing the blocks of core-shell material from the mold. This process can easily be transferred to an industrial scale.

In the two embodiments described above, the silica shell, preferably functionalized, surrounding the activated carbon core, in the form of nanoparticles or of a thin film, must have a low thickness and a mesoporosity to allow the pollutants to diffuse rapidly in the porous network and reach the silica-activated carbon interface It is at this interface of the hybrid compound that a “mixed” environment favors the trapping of polar molecules that are hardly or not trapped by the activated carbon alone or the silica only.

Filter Material

Another object of the invention is a core-shell hybrid material consisting of an activated carbon core surrounded by a shell of mesoporous sol-gel silica. According to one embodiment, the hybrid core-shell material is obtained by the coating process according to the invention described above.

All the details and embodiments set out above with respect to the nature of the sol-gel material and of the activated carbon are also valid for the hybrid core-shell material according to the invention. The core-shell hybrid material according to the invention is characterized in particular in that it contains an activated carbon core, in particular of micrometric size, preferably with a large specific adsorption surface area, in particular from 800 to 1500 m²/g, the surface of which is covered with a shell formed of mesoporous sol-gel silica. This shell is thin. Its mesoporosity allows pollutants to diffuse rapidly in the porous network and reach the silica-activated carbon interface. It is at this interface of the hybrid compound that a “mixed” environment promotes the trapping of polar molecules that are hardly or not trapped at all by activated carbon alone or silica alone. The ratio (Mass of silica/Mass of activated carbon) determined by Differential Thermal Analysis (DTA) preferably varies between 0.05 and 6, preferably between 0.05 and 2 and more preferably between 0.05 and 0.2.

In a first embodiment, the shell of the hybrid core-shell material according to the invention consists of nanoparticles of mesoporous sol-gel silica. These nanoparticles are advantageously of spherical shape, having in particular a diameter of 20 to 400 nm and preferably between 50 and 100 nm. The size of the silica nanoparticles can be determined by transmission electron microscopy. The ratio (mass of silica/mass of activated carbon) determined by Differential Thermal Analysis (DTA) preferably varies between 0.05 and 0.2. The shell core hybrid material of this embodiment can be prepared according to the first embodiment of the process of the invention described above.

In a second embodiment, the shell of the hybrid core-shell material according to the invention consists of a thin film of mesoporous sol-gel silica. The shell core hybrid material of this embodiment can be prepared according to the second embodiment of the method of the invention described above. The ratio (mass of silica/mass of activated carbon) determined by Differential Thermal Analysis (DTA) preferably varies between 0.05 and 0.2. However, in the case of hybrid materials synthesized—by mixing activated carbon with soil, this ratio is higher and varies between −4 and 6, but could be reduced to lower values for better efficiency.

Applications

According to one embodiment, the materials according to the invention find particular application in the field of air filtration and in particular in the field of food cooking appliances. The invention also relates to an air filtering system comprising the core-shell material as described above.

Anti-Odor Cover 100

The invention also relates to an anti-odor cover.

According to a first embodiment, the anti-odor cover of the invention is useful for containers which release odors and/or volatile organic compounds (VOCs).

According to one embodiment, the anti-odor cover of the invention is useful for chemical treatment tanks, such as, for example, fabric and/or leather treatment tanks, or paint tanks.

According to one embodiment, the anti-odor cover of the invention is useful for partially or totally trapping corrosive, irritant and/or toxic products.

According to a second embodiment, the anti-odor cover of the invention is particularly suitable for cooking appliances, whether or not comprising a tank intended to contain a cooking bath such as an oil bath.

According to one embodiment, the container may be an enclosure or a food preparation tank.

According to one embodiment, the receptacle relates to any household or professional cooking appliance.

According to one embodiment, the anti-odor cover 100 has a ton suitable for closing a cooking appliance such as, for example, a saucepan, a frying pan, a pressure cooker, an oil bath, or a deep fryer. According to one embodiment, the anti-odor cover 100 has a square, rectangular, round or ovoid ton.

According to one embodiment, the anti-odor cover 100 comprises or is made of a material resistant to cooking temperatures of food, preferably resistant to frying temperatures.

According to one embodiment, the anti-odor cover 100 comprises or is made of metal, glass and/or polymer.

According to one embodiment, the anti-odor cover 100 comprises an upper wall 110 and a lower wall 120, said lower wall 120 being directed towards the interior of the cooking appliance on which the anti-odor cover 100 is disposed.

According to one embodiment, the anti-odor cover 100 comprises a filter material 200 including core-shell particles comprising or consisting of an activated carbon core surrounded by a shell of sol-gel silica, preferably mesoporous. Advantageously, the filter material of the invention makes it possible to trap cooking odors, and in particular makes it possible to trap small polar molecules resulting from the decomposition of superheated oil (frying and others) such as, for example, formaldehyde, acetaldehyde, methyl and ethyl ketones, acetic acid, acrolein or acrylamide.

According to one embodiment, the upper wall 110 comprises a means for gripping the anti-odor cover such as for example a button, a handle or a handle.

According to one embodiment, the upper wall 110 comprises an opening or a means for viewing the interior of the cooking appliance on which the odor-resistant cover is disposed.

According to one embodiment, the means for viewing the interior of the cooking appliance on which the anti-odor cover is arranged is a window. According to one embodiment, the upper and lower walls of the anti-odor cover are transparent.

According to one embodiment, the anti-odor cover 100 comprises a gasket such as for example an annular sealing gasket, on the part intended to be brought into contact with the cooking appliance. Advantageously, the seal makes it possible to improve the tightness of the system formed by the cover placed on the cooking appliance, and to prevent and/or limit the escape of cooking vapors, in particular cooking odors.

According to one embodiment, the anti-odor cover 100 further comprises a system for fixing and/or anchoring to the food cooking appliance 5.

According to one embodiment, the lower wall 120 comprises a housing 121 adapted to receive the filter material of the invention 200 or a filtration system comprising said filter material 200, such as for example a filter cartridge. According to one embodiment, the filter cartridge comprises a flame-retardant fabric to prevent particles of the invention from falling into the cooking appliance. Advantageously, this configuration makes it possible to trap cooking odors when the cover is reused on a cooking appliance in operation.

According to one embodiment, the housing 121 is arranged between the upper wall 110 and the lower wall 120. Advantageously, the housing 121 comprises the filter material 200 on the side of the lower wall 120 and comprises at least one exhaust opening 111 on the side of the upper wall 110, in order to allow the passage of a flow of vapor through the cover. anti-odor 100.

Cooking appliance/Fryer 300 The invention also relates to a food cooking appliance 300 comprising a filter material as described above.

According to one embodiment, the food cooking appliance 300 is a cooking appliance comprising a tank intended to contain a cooking bath such as an oil bath.

According to one embodiment, the food cooking apparatus 300 is a saucepan, a frying pan, a pressure cooker, an oil bath, or a deep fryer. According to one embodiment, the food cooking apparatus 300 has a square, rectangular, round or ovoid shape. According to one embodiment, the food cooking appliance 300 is an electric fryer, with oil or without oil with forced hot air. According to one embodiment, the food cooking apparatus 300 is not an electric fryer. According to one embodiment, the food cooking apparatus 300 is a traditional fryer composed of an oil bath and a basket. According to one embodiment, the fryer does not include an oil bath. According to one embodiment, the fryer does not include a basket.

According to one embodiment, the food cooking apparatus 300 comprises or consists of a material resistant to cooking temperatures of food, preferably resistant to frying temperatures. According to one embodiment, the food cooking appliance 300 comprises or is made of metal, glass and/or polymer.

Other Devices

The invention also relates to any receptacle allowing odors and/or volatile organic compounds (VOCs) to escape, comprising a filter material as described above.

Although various embodiments have been described and illustrated, the detailed description should not be construed as being limited thereto. Various modifications can be made to the embodiments by those skilled in the art without departing from the true spirit and scope of the disclosure as defined by the claims.

### BRIEF DESCRIPTION OF THE FIGURES

FIG. 1 is a schematic representation of the synthesis of the core/shell materials.

FIG. 2 (A): is a TEM image of the core-shell hybrid material from Example 1.

FIG. 2 (B): is a TEM image of the hybrid core-shell material from Example 1, expansion on the surface.

FIG. 3 is a TEM image of W35 activated carbon. Expansion on the surface.

FIG. 4: (A) is a TEM image of the core-shell hybrid material from Example 2. (B) is a TEM image of the core-shell hybrid material from Example 2. Expansion on the surface.

FIG. 5 are TEM images of the core-shell hybrid materials of Example 2 complement with different proportions of NH2-TMOS: (A) 10 μL, (B) magnification of the material prepared with 10 μL, (C) 20 μL, (D) 50 μL, (E) 100 μL, (F) 200 μL.

FIG. 6 is a TEM image of the core-shell hybrid material from Example 3.

FIG. 7: is a TEM image of the core-shell hybrid material from Example 4.

FIG. 8: is a TEM image of the core-shell hybrid material from Example 5.

FIG. 9: is a TEM image of a CA rod (Darco-KGB) coated with hybrid sol-gel from Example 6. A) view of the stick. B) Zoom on its surface, C) Enlargement of the surface, D Estimation of the sol-gel thickness

FIG. 10: is an infrared spectrum of the hybrid material of Example 1 compared to the activated carbon alone.

FIG. 11: is an infrared spectrum of the hybrid material of Example 2 compared to activated carbon alone.

FIG. 12: is an infrared spectrum of the hybrid material from Example 3 compared to activated carbon alone.

FIG. 13: is an infrared spectrum of the hybrid material from Example 4 compared to activated carbon alone.

FIG. 14: is a differential thermal analysis of the product of Example 6. The sample is heated from 40° C. to 1500° C. at the rate of 50° C./min. The successive slope variations indicate the successive mass losses of the residual water, of the aminopropyl chains of the functionalized material, of the activated carbon and lastly the silica.

FIG. 15: shows an example of an air filter application. Adsorption of toluene by the silica particles alone as a function of time.

FIG. 16: shows an example of an air filter application. Adsorption of toluene by activated carbon W35 as a function of time.

FIG. 17: shows an example of an air filter application. Adsorption of toluene by Example 4 as a function of time.

FIG. 18: shows an example of an air filter application. Overlay of the graphs of activated carbon W35 alone, silica nanoparticles alone SiO₂ and Example 4, as a function of time.

FIG. 19 is a thermogravimetric analysis of the material of Example 22.

FIG. 20 is a schematic representation of the device used for establishing drilling curves.

FIG. 21 is a comparison of the adsorption capacities of the various powder filters (50 mg, material of example 18, the activated carbon W35 and the sol-gel silica SiO₂—NH2 corresponding to the sol-gel silica of the material of Example 18) exposed to a gas flow of 300 mL/min containing 25 ppm of hexaldehyde.

FIG. 22 is a comparison of the adsorption capacities of the various rod filters (Ig, material of example 18 and 18p, sol-gel silica SiO₂—NH₂ corresponding to the sol-gel silica of the material of example 18) exposed at a gas flow of 300 mL/min containing 25 ppm of hexaldehyde.

FIG. 23 is a comparison of efficiency of adsorption of hexaldehyde by two materials carrying amine functions and differentiating by amine groups with different proportions of APTES.

FIG. 24 is a comparison of the adsorption efficiency of hexaldehyde by hybrid materials functionalized by amine groups with different proportions of A PT E S.

FIG. 25 is a comparison of the adsorption efficiency of hexaldehyde by hybrid materials functionalized by primary amine groups of APTES and by primary/secondary amine groups (NH₂-TMOS).

FIG. 26 shows the trapping efficiency of various pollutants (E-2-heptenal, acetone acetaldehyde) with example 18p.

FIG. 27 is a schematic representation of the experimental setup for the detection of total VOCs generated by cooking oil.

FIG. 28 is a comparison of the trapping efficiency of total VOCs during cooking of oil by various filters.

FIG. 29 is a comparison of the effectiveness of trapping total VOCs during oil cooking by various filters differing in the nature of the activated carbon (example 18p and 24p) or by the functionalization of the silicate (examples 18p and 22p).

FIG. 30 is a representation of a first embodiment of an anti-odor cover 101a. FIG. 30A is a top view of the anti-odor cover 100 comprising an upper wall 110 on which are arranged a window 112 and a housing 121 comprising several exhaust openings 111. FIG. 30B is a bottom view of an anti-odor cover 100 comprising a lower wall 120 on which are arranged a window 112 and a housing 121 comprising the filter material 200.

FIG. 31 is a representation of a second embodiment of an anti-odor cover 100. FIG. 31A is a top view of the anti-odor cover 100 comprising an upper wall 110 on which is arranged a window 112. FIG. 31B is a bottom view of an anti-odor cover 100 comprising a lower wall 120 on which are arranged a window 112 and a housing 121 comprising the filter material 200.

### REFERENCES

1—Washing bottle
2—Ethanolic bath
3—Filter
4—PID detector
11—Pressure cooker
12—Induction hob
13—Air inlet
14—Central opening
15—Funnel
16—Tricol balloon
17—Peristaltic pump
18—Photoionization detector
19—Filter compartment
100—Anti-odor cover
110—Upper wall
111—Exhaust opening
112—Porthole
113—Gripping means
120—Lower wall
121—Housing
122—Seal
200—Filter material
300—Food cooking appliance

### EXAMPLES

### A. Synthesis of Activated Carbons Coated with Silica According to the First Embodiment

### Example 1: Synthesis of Nonfunctionalized Coated Activated Carbon

Reagents: Activated Carbon W35 (SGFRALAB), Tetraethyl orthosilicate (TEOS, CAS: 78-10-4, Molar mass=208.33 g/mol and density d=0.933), Methanol (MeOH, CAS: 67-56-1, Molar mass=32.04 g/mol and density d=0.791), Cetyltriethylammonium bromide (CTAB, CAS: 57-09-0, Molar mass=364, 45 g/mol), Ammonia (NH₄OH, CAS: 1336-21-6, Molar mass=35.05 g/mol and density d=0.9)

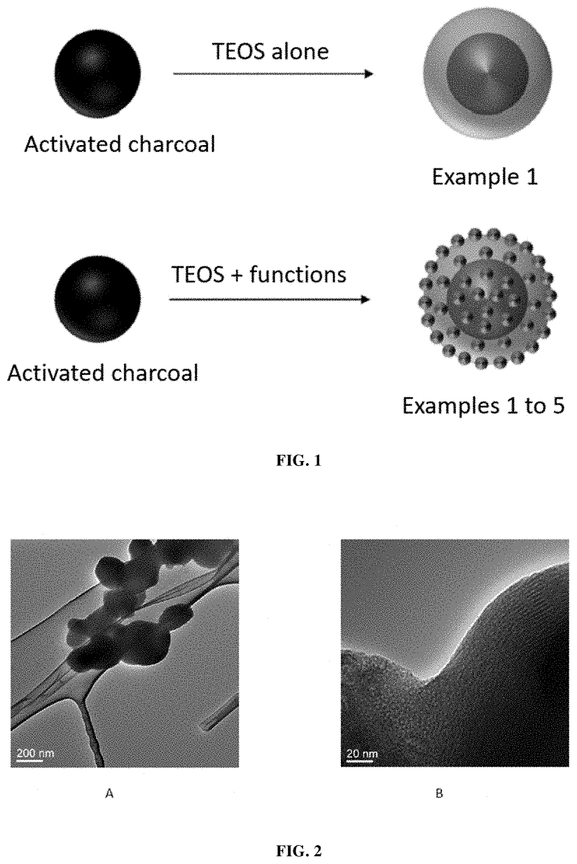

Procedure: (See FIG. 1) 0.64 g of W35 activated carbon, 0.29 g of CTAB and 150 mL of an aqueous solution of NH₄OH are mixed in a flask previously prepared at a concentration of 2,048M. The solution is left under magnetic stirring at room temperature for 1 hour. 6.5 mL of ethanolic TEOS at a concentration of 1.025 M·L⁻¹ are then added dropwise and the solution is left under stirring for a further hour at room temperature. The stirring is then stopped and the solution is left to mature overnight at 50° C. The solution is then recovered by centrifugation (12,000 rpm for 12 min). The surfactant is removed by a succession of washing with hydrochloric acid and ethanol before being stored in the latter. Before use, the materials are recovered by centrifugation (12,000 rpm for 12 min) then dried in an oven at 60° C. for 2 h.

### Example 2: Synthesis of Activated Carbons Coated with Silica Functionalized with Amine Groups

Reagents: Activated Carbon W35 (SOFRALAB), Tetraethyl orthosilicate (TEOS, CAS: 78-10-4, Molar mass=208.33 g/mol and density d=0.933), Methanol (MeOH, CAS: 67-56-1, Molar mass=32.04 g/mol and density d=0.791), Cetyltrimethylammonium bromide (CTAB, CAS: 57-09-0, Molar mass=364.45 g/mol), Ammonia (NH₄OH, CAS: 1336-21-6, Molar mass=35.05 g/mol and density d=0.9), N-(2-Aminoethyl)-3-(trimethoxysilyl) propylamine (NH₂-TMOS, CAS: 1760-24-3, Mass molar 222.36 g/mol and density d 1,028).

Procedure: (Cf. FIG. 1) In a plastic bottle are mixed 0.64 g of W35 activated carbon, 0.29 g of CTAB and 150 mL of an aqueous solution of NH₄OH previously prepared at a concentration of 2.048 M. The solution is left under magnetic stirring at room temperature for 1 h. 20 μL of NH₂-TMOS are then added followed by 6.5 mL of ethanolic TEOS at a concentration of 1.025 M·L⁻¹ and the solution is left under stirring for a further hour at room temperature. The stirring is then stopped and the solution is left to mature overnight at 50° C. The solution is then recovered by centrifugation (12,000 rpm for 12 min). The surfactant is removed by a succession of washing with hydrochloric acid and ethanol before being stored in the latter. Before use, the materials are recovered by centrifugation (12,000 rpm for 12 min) then dried in an oven at 60° C. for 2 h.

### Complement Example 2: Variation of the Quantity of Amine Functions

According to the protocol of Example 2, the amount of N-(2-Aminoethyl)-3-(trimethoxysilyl) propylamine was used with various ratios according to Table 1.

TABLE 1
Ratio of NH2-TMOS to TEOS

| V NH2-TMOS | n NH2-TMOS | nTEOS/n |
|---|---|---|
| (μL) | (μmol) | NH2-TMOS |
| 10 | 42.73 | 157 |
| 20 | 85.47 | 79 |
| 50 | 213.67 | 31 |
| 100 | 427.34 | 15 |
| 200 | 854.68 | 8 |

### Example 3: Synthesis of Activated Carbons Coated with Functionalized Silica with Acid Group

Reagents: Activated Carbon W35 (SOFRALAB), Tetraethyl orthosilicate (TEOS, CAS: 78-10-4, Molar mass=208.33 g/mol and density d=0.933), Methanol (MeOH, CAS: 67-56-1, Molar mass=32.04 g/mol and density d=0.791) Cetyltrimethylammonium bromide (CTAB, CAS: 57-09-0, Molar mass=364.45 g/me), Ammonia (NH₄OH, CAS: 1336-21-6, Molar mass=35.05 g/mol and density d=0.9), N-(Trimethoxysilylpropyl) ethylenediaminetriacetate, trisodium salt (COOH-TMOS, CAS: 128850-89-5, Molar mass=462.42 g/mol and density d=1.26).

Procedure: (Cf. FIG. 1) In a plastic bottle are mixed 0.64 g of activated carbon W35, 0.29 g of CT AB and 150 mL of an aqueous solution of NH₄OH previously prepared at a concentration of 2.048M. The solution is left under magnetic stirring at room temperature for 1 h. 20 m of COOH-TMOS are then added followed by 6.5 ml of ethanolic TEOS at a concentration of 1.025 M·L and the solution is left under stirring for a further hour at room temperature. The stirring is then stopped and the solution is left to mature overnight at 50° C. The solution is then recovered by centrifugation (12,000 rpm for 12 min). The surfactant is removed by a succession of washing with hydrochloric acid and ethanol before being stored in the latter.

Before use, the materials are recovered by centrifugation (12,000 rpm for 12 min) then dried in an oven at 60° C. for 2 h

### Example 4: Synthesis of Activated Carbons Coated with Silica Functionalized with Aromatic Groups

Reagents: Activated Carbon W35 (SOFRALAB), Tetraethyl orthosilicate (TEOS, CAS: 78-10-4, Molar mass=208.33 g/mol and density d=0.933), Methanol (MeOH, CAS: 67-56-1, Molar mass=32.04 g/mol and density d=0.791), Cetyltrimethylammonium bromide (CTAB, CAS: 57-09-0, Molar mass=364.45 g/mol), Ammonia (NH₄OH, CAS: 1336-21-6, Molar mass=35.05 g/mol and density d=0.9), Trimethoxyphenylsilane (Ar-TMOS, CAS: 2996-92-1, Molar mass=198.29 g/mol and density d=1,062).

Procedure: (Cf. FIG. 1) In a plastic bottle are mixed 0.64 g of activated carbon W35, 0.29 g of CTAB and 150 mL of an aqueous solution of NH₄OH previously prepared at a concentration of 2.048M. The solution is left under magnetic stirring at room temperature for 1 h. 20 μL of Ar-TMOS are then added followed by 6.5 mL of ethanolic TEOS at a concentration of 1.025 M·L⁻¹ and the solution is left under stirring for a further hour at room temperature. The stirring is then stopped and the solution is left to mature overnight at 50° C. The solution is then recovered by centrifugation (12000 rpm for 12 min). The surfactant is removed by a succession of washing with hydrochloric acid and ethanol before being stored in the latter. Before use, the materials are recovered by centrifugation (12,000 rpm for 12 min) then dried in an oven at 60° C. for 2 h

### Example 5: Synthesis of Activated Carbons Coated with Silica Functionalized with Urea Groups

Reagents: Activated Carbon W35 (SOFRALAB), Tetraethyl orthosilicate (TEOS, CAS: 78-10-4, Molar mass=208.33 g/mol and density d=0.933), Methanol (MeOH, CAS: 67-56-1, Molar mass=32.04 g/mol and density d=0,791), Cetyltrimethylammonium bromide (CTAB, CAS: 57-09-0, Molar mass=364.45 g/mol), Ammonia (NH₄OH, CAS: 1336-21-6, Molar mass=35.05 g/mol and density d=0.9), 3-(4-Semicarbazidyl) propyltriethoxysilane (SCPTS, CAS: 106868-88-6, Molar mass: =279.41 g/mol and density d=1.08).

Procedure: (See FIG. 1) In a plastic bottle are mixed 0.64 g of W35 activated carbon, 0.29 g of CTAB and 150 mL of an aqueous solution of NH₄OH previously prepared at a concentration between 1 and 3 mol/L, preferably 2.05 mol/L. The solution is left under magnetic stirring at room temperature for 1 h. 20 μL of Ur-TEOS are then added followed by 6.5 mL of ethanolic TEOS prepared at a concentration between 1 and 2 M·L⁻¹, preferably 1.025 M·L⁻¹ and the solution is left under stirring for a further hour at room temperature. The stirring is then stopped and the solution is left to mature overnight at 50° C. The solution is then recovered by centrifugation (12,000 rpm for 12 min). The surfactant is removed by a succession of washing with hydrochloric acid and ethanol before being stored in the latter. Before use, the materials are recovered by centrifugation (12,000 rpm for 12 min) then dried in an oven at 60° C. for 2 h.

During the syntheses, 3-(4-Semicarbazidyl) propyltriethoxysilane was also used as a precursor for the functionalization by urea groups. This can be substituted with any triethoxy or methoxy silane bearing one or more urea groups such as ureidopropyltriethoxysilane.

### B. Synthesis of Activated Carbons Coated with Silica According to the Second Embodiment

### Example 6: Synthesis of Activated Carbons in Rods Coated with Silica Functionalized with Amine Groups

Reagents: Norit RBBA-3 Activated Carbon sticks (Sigma-Aldrich), Tetramethyl orthosilicate (TMOS, CAS: 681-84-5, purity: 99%, Molar mass=152.22 g/mol and density d=1,023), Methanol (MeOH, CAS: 67-56-1, purity 99.9%, molar mass 32.04 g/mol and density d=0,791 g/cm3), 3-aminopropyltriethoxysilane (APTES, CAS 919-30-2; purity 99%, molar mass=221.37 g/mol and density d=0.946). Ultrapure deionized water.

Procedure: In a 60 mL flask containing 14.22 mL of methanol, 10.23 mL of TMOS and 0.5 mL of APTES are added. The mixture is left under stirring to obtain a homogeneous solution. 5.05 mL of water is added to the mixture and the solution is stirred vigorously. The molar proportions of the mixture thus obtained are TMOS/APTES/MeOH/water=0.97/0.03/5/4. The gelling sol after 8 min. One to three castings are made after 1 min on activated carbon sticks positioned on a sieve. The sticks covered with a film of sol-gel material are dried in an oven at 80°.

### Examples 7A and 7B: Synthesis of Activated Carbons in Rods Coated with Silica Functionalized with Amine Groups

Reagents: Norit RBBA-3 Activated Carbon (Sigma-Aldrich), Tetramethylorthosilicate (TMOS, CAS 681-84-5, Molar mass=152.22 g/mol and density d=1.023), Ethanol (EtOH, CAS: 64-17-5, Molar mass=46.07 g/mol and density d=0,789), 3-aminopropyltriethoxysilane (APTES, CAS 919-30-2; Molar mass=221.37 g/mol and density d=0,946).

Procedure: In a 60 ml flask containing 14.13 ml of ethanol, 9.86 ml of TMOS and 0.99 ml of APTES are added. The mixture is left under stirring to obtain a homogeneous solution. 5.02 mL of water is added to the mixture and the solution is stirred vigorously. The molar proportions of the mixture thus obtained are TMOS/APTES/EtOH/water=0.94/0.06/5/4. The sol gelling after 8 min, the casting is carried out after 1 min on activated carbon sticks positioned on a sieve (material 6A). (mass of activated carbon 0.7428 g).

The remaining soil is left to mature for an additional 2 min, at the end of which a new casting is carried out on new activated carbon sticks (material 6B) (mass of activated carbon 0.7315 g). The sticks covered with a film of sol-gel material are dried in an oven at 80°.

### C. Synthesis of Hybrid Activated Carbons Coated with Functionalized Silica by Simple Mixing of a Sol and Activated Carbon According to the Second Embodiment

### Example 8: Synthesis of Hybrid Materials by Mixing Activated Carbons with a Sol of Silicon Precursors, One of which is Functionalized with Acetoxy Groups

Reagents: Activated carbon powder Darco KG-B (Sigma-Aldrieh), Tetramethyl orthosilicate (TMOS, CAS 681-84-5, purity 99%, Molar mass=152.22 g/mol and density d=1.023), methanol (MeOH, CAS: 67-56-1, purity 99.9%, Molar mass=32.04 g/mol and density d=0.791), Acetoxyetbyltrimethoxysilane (AETMS, CAS: 72878-29-6, purity 95%, Mass molar=250.36 g/mol and density d=0.983), ultra-pure deionized water, 28% aqueous ammonia solution.

Procedure: In a 60 mL flask containing 14.13 mL of methanol, 10.29 mL of TMOS and 0.55 mL of AETMS are added. The mixture is left under stirring to obtain a homogeneous solution. 4.73 mL of water is added to the stirred mixture and 0.3 mL of 28% aqueous ammonia solution is added last. The activated carbon (0.7514 g) is added 20 s after vigorous stirring for 10 s, then the Sol is poured into a honeycomb mold. The molar proportions of the mixture thus obtained are TMOS/AETMS/MeOH/water=0.98/0.02/5/4 with an NH₄OH concentration of 0.148 M. After gelation, the mold is dried under an inert gas flow. After demoulding, black granules of cylindrical shape with dimensions 0.7 (L)*0.3 (diameter) cm are obtained.

### Example 9: Synthesis of Hybrid Materials by Mixing Activated Carbons with a Sol of Silicon Precursors, One of which is Functionalized with Acetoxy Groups

Same synthesis as in Example 8. Activated carbon is in powder form, Activated Carbon W35 (SOFRALAB) (0.7539 g).

### Example 10: Synthesis of Hybrid Materials by Mixing Activated Carbons with a Sol of Silicon Precursors, One of which is Functionalized with Glycidylloxy Groups

Reagents: Activated carbon powder Darco KG-B (Sigma-Aldrich), Tetramethyl orthosilicate (TMOS, CAS 681-84-5, purity 99%, Molar mass=152.22 g/mol and density d=1.023), (MeOH, CAS: 67-56-1, purity 99.9%, Molar mass=32.04 g/mol and density d=0.791), 3-glycidyloxypropylltriethoxysilane (GPTES, CAS: 2602-34-8, Molar mass=278, 42 g/mol and density d=1.004). ultrapure deionized water, 28% aqueous ammonia solution.

Procedure: 10.25 ml are added to a 60 ml flask containing 14.13 ml of methanol of TMOS and 0.59 mL of GPTES. The mixture is left under stirring to obtain a homogeneous solution. 4.73 mL of water is added to the stirred mixture and 0.3 mL of 28% aqueous ammonia solution is added last. The activated carbon (0.7505 g) is added 20 s after vigorous stirring for 10 s, then the Sol is poured into a honeycomb mold. The molar proportions of the mixture thus obtained are TMOS/GPTES/MeOH/water=0,967/0,023/5/4 with a NH₄OH concentration of 0.148 M. After gelation, the mold is dried under an inert gas flow. After demoulding, black granules of cylindrical shape with dimensions 0.7 (L)*0.3 (diameter) cm are obtained.

### Example 11: Synthesis of Hybrid Materials by Mixing Activated Carbons with a Sol of Silicon Precursors, One of which is Functionalized with Glycidylloxy Groups

Same synthesis as in Example 10. The activated carbon in this case is in powder form, Activated Carbon W35 (SOFRALAB) (0.7527 g).

### Example 12 Synthesis of Hybrid Materials by Mixing Activated Carbons with Sol of Silicon Precursors in which Pun is Functionalized with Amide and Amine Groups

Reagents: Darco KG-B powdered activated carbon (Sigma-Aldricb), Tetramethyl orthosilicate (TMOS, purity 99%. CAS; 681-84-5, Molar mass=152.22 g/mol and density d=1.023), (MeOH, CAS: 67-56-1, purity 99.9%, Molar mass=32.04 g/mol and density d=0.791), 3-(4-semicarbazido) propyltriethoxysilane (SCPTS), CAS: 106868-88-6, purity 95%, Molar mass=279.41 g/mol and density d=1.08). ultrapure deionized water, 28% aqueous ammonia solution.

Procedure: In a 60 mL flask containing 14, 14 mL of methanol, 10.27 mL of TMOS and 0.56 mL of SCPTS are added. The mixture is left under stirring to obtain a homogeneous solution. 4.73 mL of water is added to the stirred mixture and 0.3 mL of 28% aqueous ammonia solution is added last. The activated carbon (0.7506 g) is added for 20 s after vigorous stirring for 10 s, then the Sol is poured into a honeycomb mold. The molar proportions of the mixture thus obtained are TMOS/SCPTS/MeOH/water=0.977/0.023/5/4 with a NH₄OH concentration of 0.148 M. After gelation, the mold is dried under an inert gas flow. After demoulding, black granules of cylindrical shape with dimensions 0.7 (L)*0.3 (diameter) cm are obtained.

### Example 13: Synthesis of Hybrid Materials by Mixing Activated Carbons with a Sol of Silicon Precursors, One of which is Functionalized with Amide and Amine Groups

Same synthesis as in Example 12. The activated carbon is in this case in powder form, Activated Carbon W35 (SOFRALAB) (0.7507 g).

### Example 14: Synthesis of Hybrid Materials by Mixing Activated Carbons with Sol of Silicon Precursors in which One is Functionalized with Aromatic Groups (PhTMOS)

Reagents: Darco KG-B powdered activated carbon (Sigma-Aldrich), Tetramethyl orthosilicate (TMOS, purity 99%. CAS: 681-84-5, Molar mass=152.22 g/mol and density d=1.023), (MeOH, CAS: 67-56-1, purity 99.9%, Molar mass=32.04 g/mol and density d=0.791), (PhTMOS), CAS: 2996-92-1, purity 98%, Molar mass=198.29 g/mol and density d 1.062 g/cm3) Ultrapure deionized water, 28% aqueous ammonia solution.

Procedure: In a 60 mL flask containing 14.25 mL of methanol, 10.27 mL of TMOS and 0.4 mL of PhTMOS are added. The mixture is left under stirring to obtain a homogeneous solution. 4.78 mL of water is added to the stirred mixture and 0.3 mL of 28% aqueous ammonia solution is added last. The activated carbon (0.75 g) is added 20 s after vigorous stirring for 10 s, then the Sol is poured into a honeycomb mold. The molar proportions of the mixture thus obtained are TMOS/PhTMOS/MeOH/water=0,977/0,023/5/4 with a NH₄OH concentration of 0.148 M. After gelation, the mold is dried under an inert gas flow. After demoulding, black granules of cylindrical shape with dimensions 0.7 (L)*0.3 (diameter) cm are obtained.

### Example 15: Synthesis of Hybrid Materials by Mixing Activated Carbons with a Sol of Silicon Precursors, One of which is Functionalized with Aromatic Groups (PhTEOS)

Reagents: Activated carbon powder Darco KG-B (Sigma-Aldrich), Tetramethylortho silicate (TMOS, purity 99%, CAS; 681-84-5, Molar mass=152.22 g/mol and density d=1.023), (MeOH, CAS: 67-56-1, purity 99.9%, Molar mass=32.04 g/mol and density d=0.791), (PhTEOS), CAS: 780-69-8, purity 98%, molar mass=240.37 g/mol and density d=0.996 g/cm3 ultrapure deionized water, 28% aqueous ammonia solution.

Procedure: In a 60 mL flask containing 14.2 mL of methanol, are added 10.23 mL of TMGS and 0.52 mL of PhTEOS. The mixture is left under stirring to obtain a homogeneous solution. 4.75 ml of water are added to the stirred mixture and 0.3 ml of 28% aqueous ammonia solution is added last. The activated charcoal (0.75 g) is added 20 s after stirring vigorously for 10 s, then the Sol is poured into a honeycomb mold. The molar proportions of the mixture thus obtained are TMOS/PhTEOS/MeOH/water=0.977/0.023/5/4 with an NH₄OH concentration of 0.148 M. After gelation, the mold is dried under an inert gas flow. After demoulding, black granules of cylindrical shape with dimensions 0.7 (L)*0.3 (diameter) cm are obtained.

### Example 16: Synthesis of Hybrid Materials by Mixing Activated Carbons with a Sol of Silicon Precursors One of which is Functionalized with Amine Groups

Reagents: Activated carbon powder Darco KG-B (Sigma-Aldrich), Tetramethylorthosilicate (TMOS, purity 99%, CAS 681-84-5, Molar mass=152.22 g/mol and density d=1,023), (MeOH, CAS: 67-56-1, purity 99.9%, Molar mass=32.04 g/mol and density d=0.791), 3-aminopropyltriethoxysilane (APTES, CAS 919-30-2; Molar mass=221.37 g/mol and density d=0.946). ultra-pure deionized water.

Procedure: In a 100 mL vial containing 23.67 mL. of methanol, 17.07 mL of TMOS and 0.833 mL of APTES are added. The mixture is left under stirring to obtain a homogeneous solution. 8.43 mL of water are added to the mixture with stirring. The activated carbon (0.5152 g) is added 1 min s after vigorous stirring for 30 s, then the Sol is poured into a honeycomb mold.

The molar proportions of the mixture thus obtained are TMOS/APTES/MeOH/water=0,977/0,023/5/4. After gelation, the mold is dried under an inert gas flow. After removal from the mould, black granules are obtained in a cylindrical shape with a size of 0.6 (L)*0.3 (diameter) cm.

### Example 17: Synthesis of Hybrid Materials by Mixing Activated Carbons with a Sol of Silicon Precursors, One of which is Functionalized with Amine Groups

Same synthesis as in Example 16. The activated carbon in this case is in powder form, Activated Carbon W35 (SOFRALAB) (0.5159 g).

### D. Characterization of Materials

Transmission Electron Microscopy

In order to demonstrate the fact that the activated carbon is fully coated (encapsulated) with a layer of nano-porous sol-gel material, the materials prepared in Examples 1 to 5 were characterized by transmission electron microscopy (TEM).

TEM grids are prepared as follows: 1 mg of material is suspended in 1 mL of ethanol and then vortexed for a few seconds. 10 μL of solution are placed on a grid and then the grid is allowed to air dry for a few minutes before use.

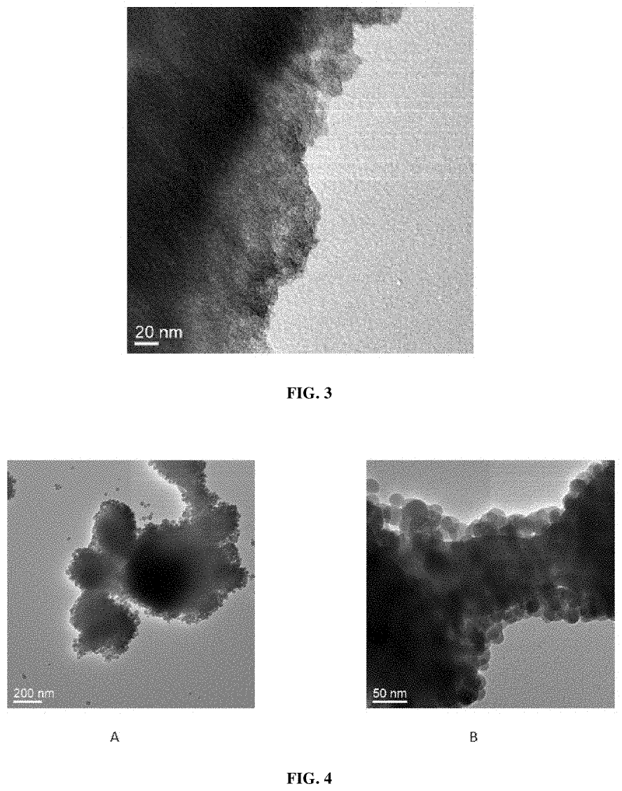

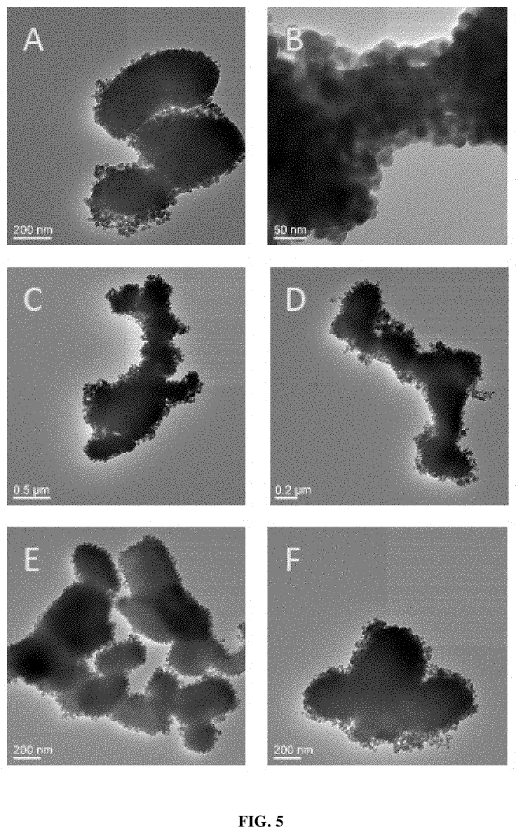

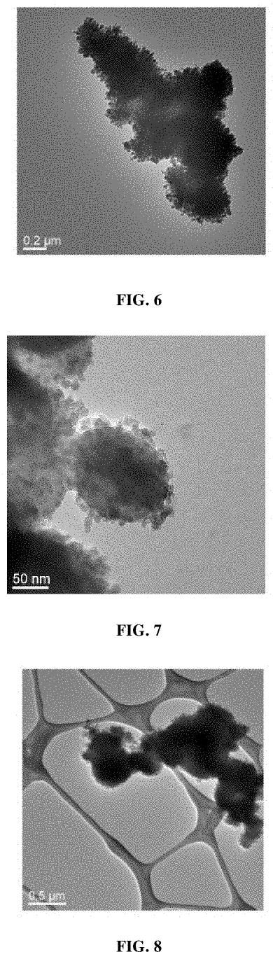

The TEM images of the activated carbon W35 (FIG. 3) and of the different materials synthesized in Examples 1 to 5 show that the activated carbon is completely covered with the sol-gel material, thus highlighting the obtaining of a hybrid core-shell material consisting of an activated carbon core surrounded by a sol-gel material (FIGS. 2A, 2B, 4A, 4B, 5, 6, 7 and 8). TEM images of activated carbon encapsulated in different functionalized sol-gel silicas show that the addition of a silica co-precursor allows the adhesion of silica nanoparticles around the materials in addition to their covering by it.

Scanning Electron Microscopy (SEM) is a powerful technique for observing surface topography. It is mainly based on the detection of secondary electrons emerging from the surface under the impact of a very fine primary electron brush which scans the observed surface and makes it possible to obtain images with a resolving power often less than 5 nm and great depth of field. The instrument makes it possible to form an almost parallel, very fine (down to a few nanometers) brush of electrons strongly accelerated by voltages adjustable from 0.1 to 30 keV, to focus it on the area to be examined and to sweep it gradually. Appropriate detectors collect significant signals while scanning the surface and form various meaningful images. The images of the samples were taken with the “Ultra 55” SEM from Zeiss. Conventionally, the samples are observed directly without any particular deposit (metal, carbon).

FIG. 9 shows the SEM images of an activated carbon rod covered with a thin film of sol-gel material and the successive enlargements of the surface showing the cracks in the silicate layer.

Infrared Spectroscopy

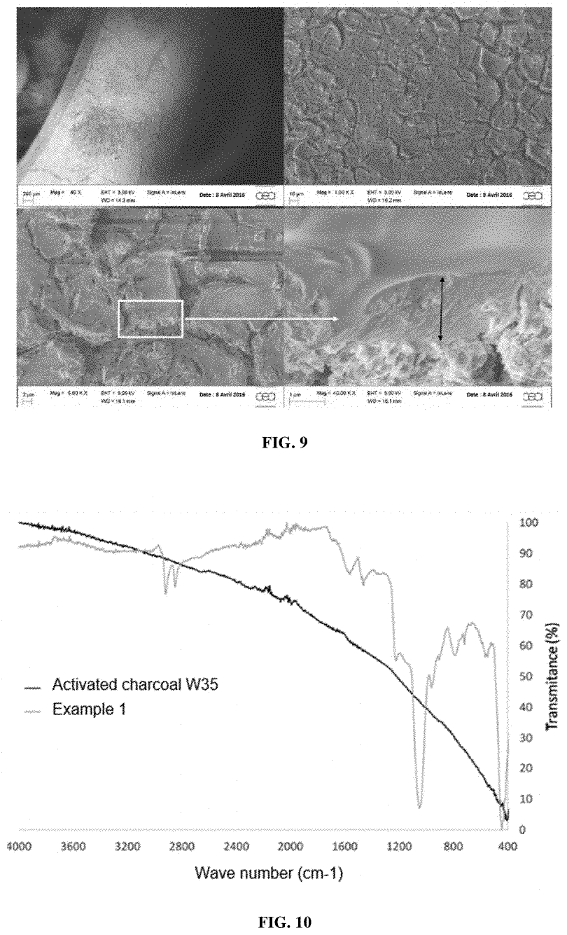

Fourier Transform InfraRed spectroscopy (FTIR) is a useful analytical technique for determining, identifying or confirming the structure of known and unknown products. An infrared spectrum makes it possible to easily demonstrate the presence of certain functional groups, and can serve as a “spectroscopic identity card” for a molecule or a material. The ATR (Attenuated Total Reflectance) module is installed on the IR spectrometer (FIG. 10). The principle consists of bringing a crystal (ZnSe or diamond) into contact with the sample to be analyzed. The IR beam propagates in the crystal; if the refractive index of the crystal is greater than that of the sample, then the beam undergoes total reflections beyond a certain angle of incidence at the sample/crystal interface with the exception of a wave, called an evanescent wave which emerges from the crystal and is absorbed by the sample. It is this evanescent wave that is responsible for the observed IR spectrum. The depth of penetration is of the order of 1 to 2 micrometers, which therefore provides surface information. This is particularly interesting for the analysis of pure samples (without dilution in a KBr matrix) since the risk of the peaks saturating is very low. In addition, at low energies, the resolution is generally better than for a “classic” transmission spectrum. The IR spectra were carried out with the FTIR-ATR “Alpha-P” module from Bruker.

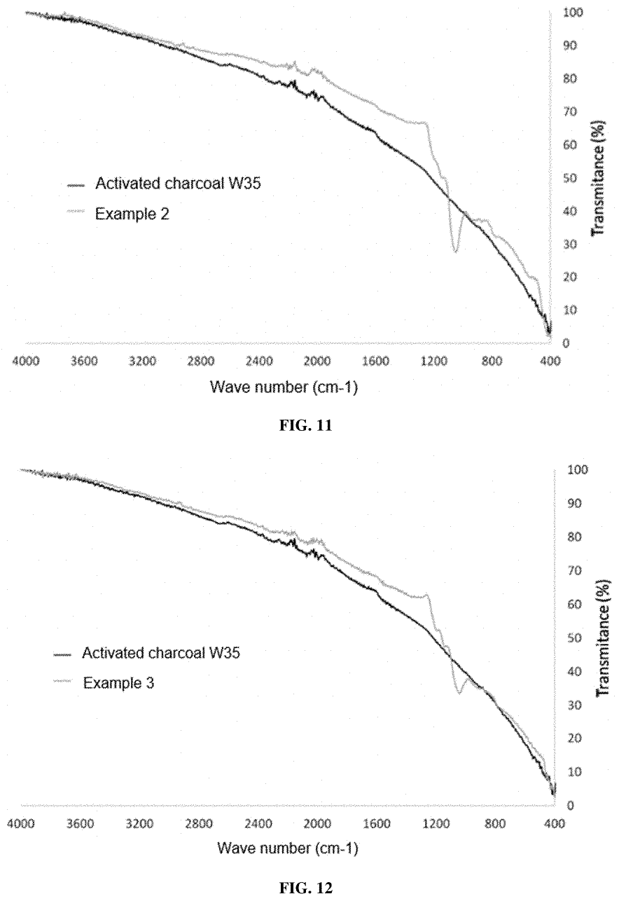

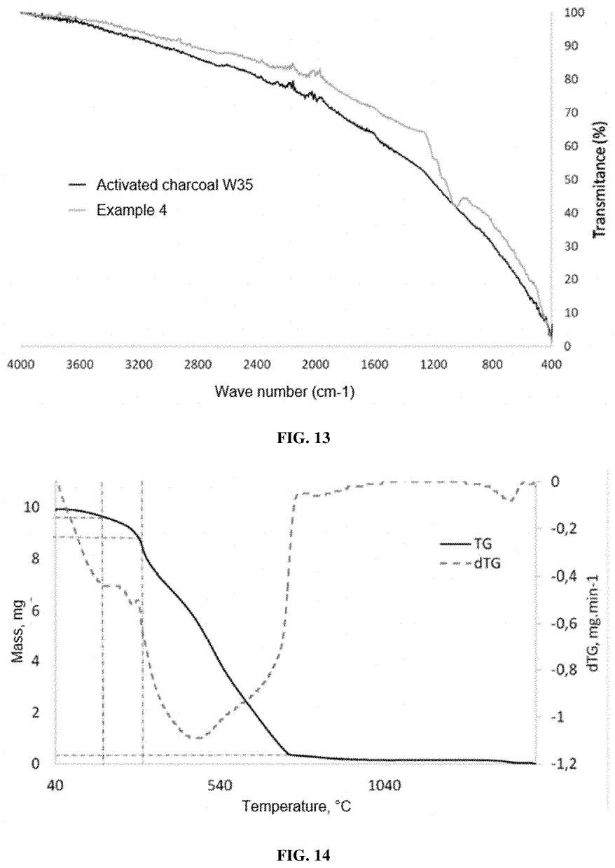

The infrared spectra of the different materials synthesized in Examples 1 to 4 clearly show the presence of silica in the materials by the peak at 1050-1100 cm. 1 corresponding to the elongation vibrations of the Si—O bonds (FIGS. 10-13).

Differential Thermal Analysis

Thermogravimetric analysis involves placing a sample in an oven under a controlled atmosphere and measuring changes in mass as a function of temperature. The gradual increase in temperature, or temperature ramp, induces the evaporation of solvents and the specific degradation of each of the organic constituents of the sample. The reduction in mass corresponding to these losses makes it possible to quantify the proportions of each constituent in the material. A Setaram brand TGA—92-1750 type device is used for a double measurement of each sample. The protocol is as follows: approximately 10 mg of monolith are finely ground, weighed and placed in the balance of the apparatus. The whole is placed in the oven and placed under a flow of synthetic air of 1 10 mL·min-1 of F. LD quality. The oven initially at 40° C. is heated up to 1500° C. with a ramp of 50° C. Min-1. After a plateau of 10 minutes at 1500° C., the temperature is reduced to room temperature at a speed of −90° C. Mini.

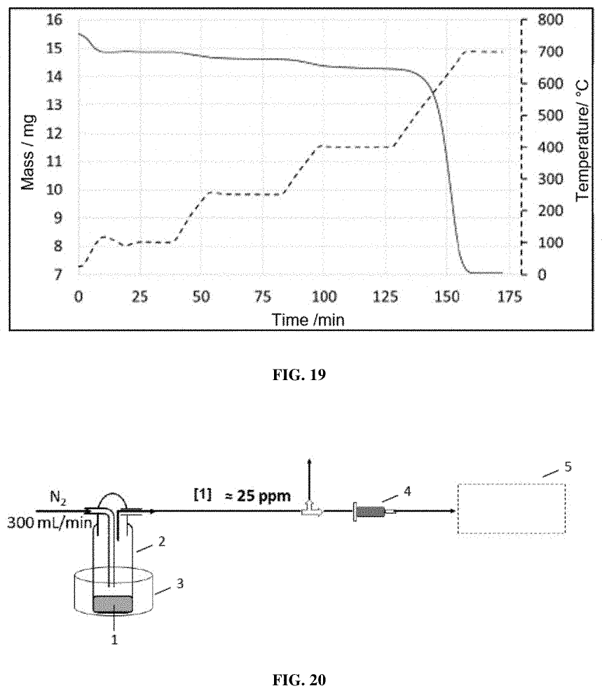

FIG. 14 shows the ATG of Example 6. From the material losses at different temperatures (H2O, Aminopropyl chains, CA), it is possible to deduce the mass of CA and silicate, the proportions of which are 85.4 and 14.6% respectively for CA and silica functionalized. FIG. 19 shows the ATG of the material of Example 22.

### E. Application Examples

### Application Example 1: Tests for Air Pollution Abatement

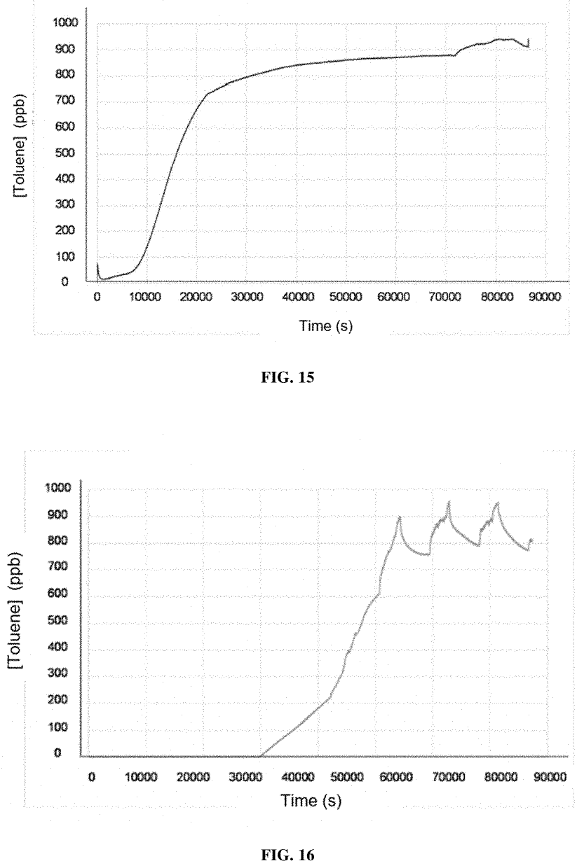

An exemplary use of Example 4 is shown for the retention of toluene. A material piercing curve was performed (FIG. 15). For this purpose, a 10 mL syringe, fitted with 2 tips, is filled with 100 mg of Example 4, then is exposed to a flow of 350 mL/min of a gas mixture (N2+toluene) containing 1 ppm (3.77 mg/m3) of toluene. The toluene content upstream of the syringe is measured and that in ava1 is monitored over time. The measurement of the toluene content is carried out with a PID detector, ppbRAE

The piercing curve, shown, below, indicates that the nanoparticles alone retain very little toluene. Indeed, traces of the latter were observed from the first minutes of the experiment and the concentration of toluene bases was found at the outlet of the syringes after 19b.

In the case of the Activated Carbon alone (FIG. 16), this completely adsorbs the toluene for 83 hours before letting it pass gradually. It is only after 151 hours that the same concentration of toluene is observed at the outlet as at the inlet of the syringe.

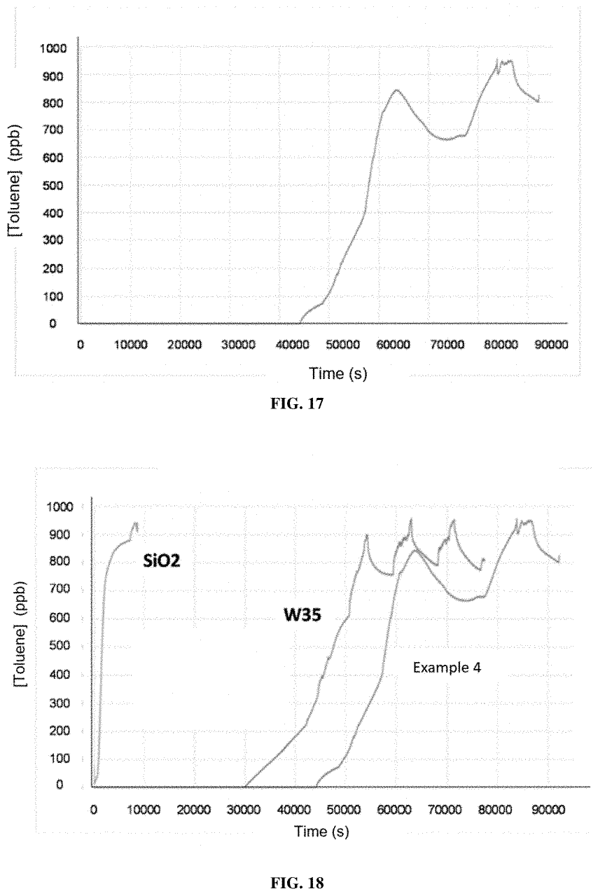

Finally, in the case of Example 4 (FIG. 17), it can be seen on the piercing curve that the appearance of toluene at the syringe outlet only occurs after 123 hours and that the original concentration of toluene does not occur. was found only after 178 hours. This result demonstrates that our materials have a much greater adsorbing power than activated carbon alone and have utility in possible applications as an air filter.

FIG. 18 makes it possible to compare the toluene trapping efficiencies of the different materials.

### Application Example 2: Adsorption of Hexaldehyde by Materials in Powder Form

A comparison of the efficiency of hybrid composite materials with those of NORIT W35 activated carbon and functionalized silicate matrices (SiO₂—NH₂, example 18, hybrid material and sol-gel silica alone is carried out with a monopollutant, hexaldehyde. This compound is present both in indoor air (emission from pine furniture) and abundantly emitted during the decomposition of overheated oil in fried foods. The adsorption capacity of materials exposed to a calibrated flux of hexaldehyde was determined with the establishment of the drilling covers.

The device used for establishing the drilling curve is shown in FIG. 20. The generation of a calibrated gas mixture is obtained by sweeping the vapor phase of pure hexanal 1 contained in a washing flask 1 maintained at −40° C. using an ethanolic bath 2. At this temperature, the gas mixture contains 25 ppm of hexaldehyde (102 mg/m³). A filter 3 consisting of a 6 L syringe fitted with 2 nozzles filled with 50 mg of the material to be tested is exposed to the flow of the gas mixture. Since NORIT W35 activated carbon is in the form of micrometric powder, the functionalized silicate matrices and hybrid materials were also ground into micrometric powder. The hexaldehyde content upstream of the syringe is measured and that downstream is monitored over time. The hexaldehyde content is measured with a PID detector, ppbRAE 4.

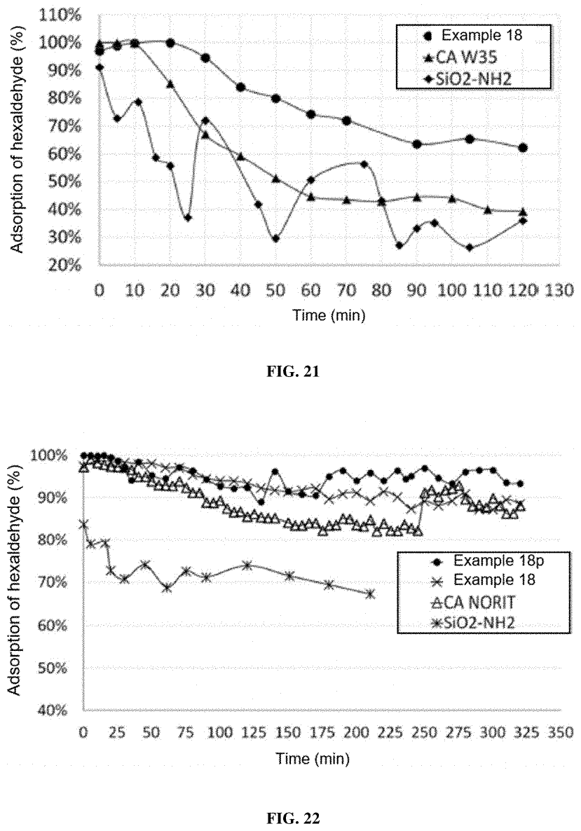

The ratio ([Hexaldehyde] upstream−[hexaldehyde] downstream)*100/[hexaldehyde] upstream makes it possible to deduce the quantity trapped by the material (FIG. 21).

The silica material functionalized with amine groups (SiO₂—NH₂) shows a low efficiency quite similar to that of activated carbon over long periods (FIG. 21). The hybrid material functionalized by amine groups (Example 18), which combines the adsorption capacity of activated carbon and the irreversible adsorption capacity of functionalized silica, is the best performing.

### Application Example 3: Adsorption of Hexaldehyde by Cylindrical-Shaped Materials

The effect of material shape on hexaldehyde scavenging capacity is studied. The materials are in the form of cylindrical rods. The material adsorption capacity was determined for hexaldehyde with the device in FIG. 20. For this purpose, a 6 mL syringe, fitted with 2 tips is filled with 1 g of material and is then exposed to a flow of 300 mL/min of a gas mixture (N2+hexaldehyde) containing 25 ppm (102 mg/m³) of hexaldehyde. The hexaldehyde content upstream of the syringe is measured and that downstream is monitored over time. The hexaldehyde content is measured with a PID detector, ppbRAE The ratio ([Hexaldehyde] upstream−[hexaldehyde] downstream)*100/[hexaldehyde] upstream makes it possible to deduce the amount trapped by the material (FIG. 22).

The materials tested are listed in Table 2 below:

TABLE 2

| | |
|---|---|
| NORIT RBAA-3 | Activated carbon in sticks of dimensions |
| | 0.6(L)*0.3(diameter) cm, l g |
| SiO₂-NH₂ | Silica material functionalized by amine |
| | groups of dimensions |
| | 0.6(L)*0.4(diameter) cm, l g |
| Exemple 18p | Silica material functionalized by |
| | amine groups of dimensions |
| | 0.95(L)*0.25(diameter) cm, l g |
| Exemple 18 | Silica material functionalized by |
| | amine groups of dimensions |
| | 0.95(L)*0.5(diameter) cm, l g |

The silica material alone functionalized with amine groups exhibits a markedly less efficient adsorption than the activated carbon alone and the hybrid materials (FIG. 22). Examples 18 and 18p show more efficient hexaldehyde adsorption than NORIT RBBAA-3 activated carbon even though the activated carbon granules are smaller. From this study, it appears that the size of the materials influences the trapping of pollutants. The smaller the size of the rods, the more dense the filter will be, with an increase in the tortuosity of the path of the gas flow which favors the trapping of the pollutant.

### Application Example 4: Hexaldehyde Adsorption by Functionalized Hybrid Materials Differing in the Proportion of Activated Charcoal

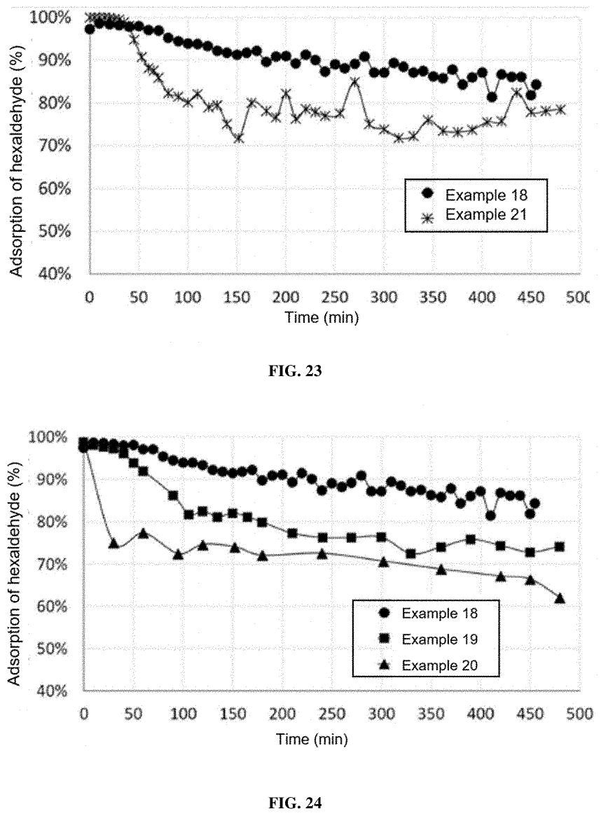

The effect of reducing the proportion of activated carbon was studied for the filter with 5% APTES. The adsorption capacity of the materials was determined from their exposure to a calibrated flux of hexaldehyde. For this purpose, a 6 mL syringe, fitted with 2 tips is filled with 1 g of stick material, then is exposed to a flow of 300 mL/min of a gas mixture (N2+hexaldehyde) containing 25 ppm (102 mg/m³) hexaldehyde. The hexaldehyde content upstream of the syringe is measured and that downstream is monitored over time. The hexaldehyde content is measured with a PIB, ppbRAE detector. The ratio ([Hexaldehyde] upstream−[hexaldehyde] downstream)*100/[hexaldehyde] upstream makes it possible to deduce the quantity trapped by the material (FIG. 23).

The materials tested are listed in Table 3 below:

TABLE 3

| | |
|---|---|
| Example 18 | 5% APTES − [W35] = 222.6 mg/mL, |
| | cylindrical granules, l g |
| Example 21 | 5% APTES − [W35] = 148.4 mg/mL, |
| | cylindrical granules, l g |

Increasing the proportion of activated carbon from 148.4 to 222.6 g/L improves the performance of the filter. The optimum amount of CA W35 in soil is 222.6 g/L (FIG. 23).

### Application Example 5: Adsorption of Hexaldehyde by Hybrid Materials Functionalized by Primary Amine Groups Differing in the Proportion of Primary Amine (APTES)

The effect of the proportion of silicon precursors functionalized with primary amine groups (APTES) was studied. The adsorption capacity of the materials was determined from their exposure to a calibrated flux of hexaldehyde. For this purpose, a 6 mL syringe, fitted with 2 tips is filled with 1 g of material and is then exposed to a flow of 300 mL/min of a gas mixture (N2+hexaldebyde) containing 25 ppm (102 mg/m³) hexaldehyde. The hexaldehyde content upstream of the syringe is measured and that downstream is monitored over time. The hexaldehyde content is measured with a PIB, ppbRAE detector. The ratio ([pollutant] upstream−[pollutant] downstream)*100/[pollutant] upstream makes it possible to deduce the quantity trapped by the material (FIG. 24).

The materials tested are listed in Table 4 below:

TABLE 4

| | |
|---|---|
| Example 18 | 5% APTES − [W35] = 222.6 mg/mL, |
| | cylindrical granules, l g |
| Example 19 | 10% APTES − [W35] = 222.6 mg/mL, |
| | cylindrical granules, l g |
| Example 20 | 15% APTES − [W35] = 222.6 mg/mL, |
| | cylindrical granules, l g |

For this example of application, we see that the percentage of silica precursor functionalized by amine groups (APTES) has an impact on the adsorption capacity. The results indicate that the more the proportion of amine groups increases, the more the trapping capacity of hexanal decreases. This phenomenon is probably due to the increase in the intrinsic basicity of the material which hinders the reaction between the amines and Hexanal. Indeed, the reaction between amines and aldehydes is favored in an acidic medium. The optimized percentage of silica precursor functionalized with amine groups (APTES) is 5% for the trapping of an aldehyde.

### Application Example 6: Adsorption of Hexaldehyde by Hybrid Materials Functionalized with Primary Amine Groups (APTES) and with Primary/Secondary Amine Groups (TMPED)

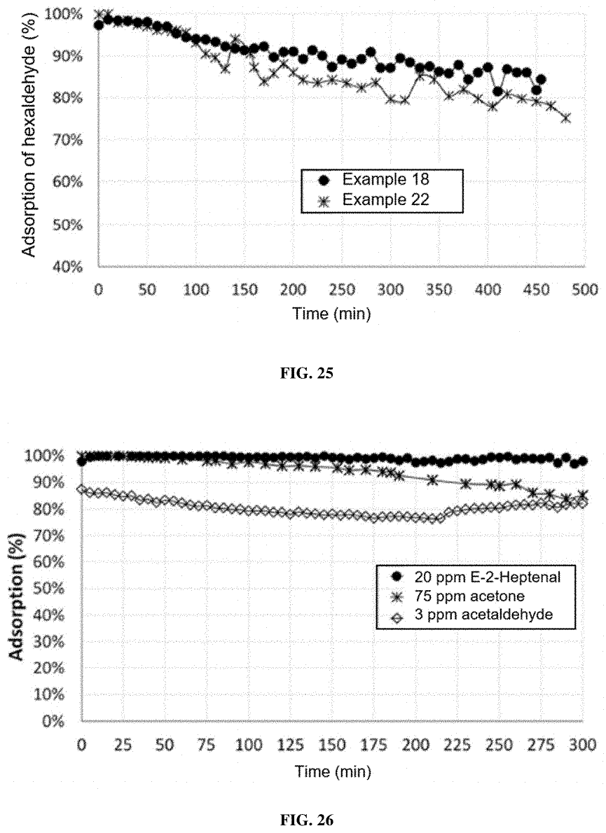

The effect of the amine precursor nature was studied for the filter comprising 5% APTES and 5% TMPED. The adsorption capacity of the materials was determined from their exposure to a calibrated flux of hexaldehyde. For this purpose, a 6 mL syringe, fitted with 2 tips is filled with 1 g of material then is exposed to a flow of 300 mL/min of a gas mixture (N2+hexaldehyde) containing 25 ppm (102 mg/m3) of hexaldehyde. The hexaldehyde content upstream of the syringe is measured and that downstream is monitored over time. The hexaldehyde content is measured with a PIB, ppbRAE detector. The ratio ([pollutant] upstream−[pollutant] downstream)*100/[pollutant] upstream makes it possible to deduce the quantity trapped by the material (FIG. 25).

The materials tested are listed in Table 5 below:

TABLE 5

| | |
|---|---|
| Example 18 | 5% APTES − [W35] = 222.6 mg/mL, |
| | cylindrical granules, l g |
| Example 22 | 5% NH₂-TMOS − [W35] = 222.6 mg/mL, |
| | cylindrical granules, l g |

As expected, Example 18 exhibits a more efficient adsorption capacity than Example 22 because the intrinsic basicity of the matrix of Example 18 is lower.

### Application Example 7: Adsorption of Acetaldehyde, Acetone and E-2-Heptenal by the Hybrid Material Functionality by Amine Groups (Example 18)

An example of the use of Example 18p is shown for the retention of acetaldehyde, acetone and E-2-heptenal. The adsorption capacity of the materials was determined from their exposure to a calibrated flow of a pollutant. For this purpose, a 6 mL syringe, fitted with 2 nozzles is filled with Ig of granules of example 18p, then is exposed to a flow of 300 mL/min of a gas mixture (N2+hexaldehyde) containing 20 ppm E-2-heptenal, i.e. 75 ppm acetone or 3 ppm acetaldehyde. The pollutant content upstream of the syringe is measured and that downstream is monitored over time. The hexaldehyde content is measured with a PIB, ppbRAE detector. The ratio ([pollutant] upstream−[pollutant] downstream)*100/[pollutant] upstream makes it possible to deduce the quantity trapped by the material (FIG. 26).

The material of example 18p traps heptenal very well, but a little less acetone and acetaldehyde which are small. Despite everything, the acetone and acetaldehyde entrapment rates remain high after 5 hours of exposure (>80%).

### Application Example 8: Test to Trap Total VOCs from Oxidation of Oil by the Various Filters (Frying Odors)

Hundreds of volatile compounds are generated by the oxidation of oil used as a heat carrier for cooking food. Oxidation initially leads to the formation of very unstable primary products (hydroperoxides, free radicals, conjugated dienes) and quickly broken down into secondary products (aldehydes, ketones, alcohols, acids, etc.).

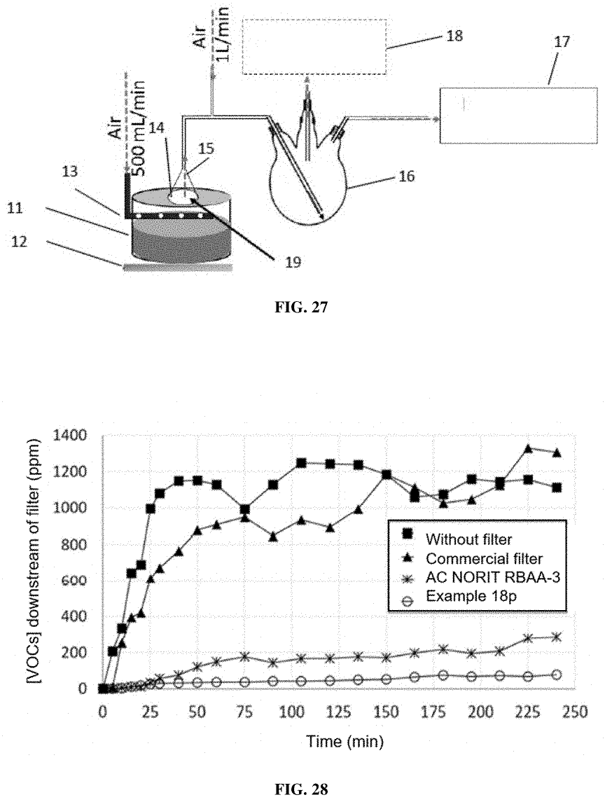

The device used for cooking oil and recovering total volatile organic compounds (VOCs) is shown schematically in FIG. 27. This is a pressure cooker 11 operating on an induction hob 12 with a sealed cover having an air inlet 13 and a central opening 14 of 11 cm in diameter on which a funnel 15 of 15 cm in diameter rests. The air inlet allows the headspace to be swept at 500 mL/min in order to collect the VOCs for measurement. The VOCs are collected using the funnel and the gas mixture is diluted with dry air (1 L/min) before being drawn into a 500 ml three-necked 16 flask. The gas mixture is drawn at 1.5 mL/min using a peristaltic pump 17 in order to homogenize the atmosphere in the flask. The VOCs are measured with a photoionization detector (PID) 18, the head of which is held in the balloon. In this study, 2 liters of sunflower oil for frying was continuously heated to 80° C. for 4 h. The filter compartment 19 is filled with 30 g of material (example 18p or NORIT RBAA-3 activated carbon) or with a commercial filter (foam impregnated with activated carbon, Ref.: SEB-SS984689). The content of total VOCs downstream of the filter is monitored over time using the PID detector, ppbRAE

FIG. 28 shows the comparative performance of the various filters during oil cooking. The commercial filter retains very little total VOCs. The adsorption of total VOCs by NORIT RBAA-3 activated carbon is also less efficient than the hydride composite material although these two materials show similar adsorption in the case of the monopollutant adoption study.

### Application Example 9: Tests to Trap Total VOCs Resulting from the Oxidation of the Oil by Functionalized Hybrid Materials (Example 18p and 24p) Differing by the Nature of the Activated Carbon or by the Functionality of the Matrix (Examples 18p and 22p)

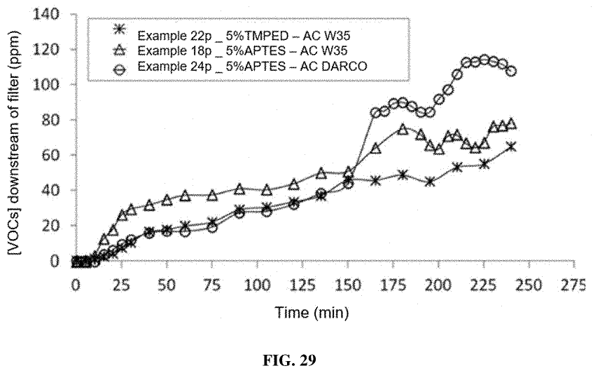

FIG. 29 shows the comparative performance of the various filters during oil firing. In this study, 2 liters of sunflower oil for frying were heated continuously for 4 hours at 180° C. The filter compartment is filled with 30 g of material (examples 18p, 22p and 24p). The device shown in FIG. 27 is used for collecting the total VOCs downstream of the various filters.

Contrary to FIG. 25 where the efficiency of the material of example 18p is better than that of example 22p for a hexaldehyde monopollutant, for the total VOCs originating from the cooking of oil, a better efficiency of the material of the oil is observed in example 22p. Note that these efficiencies correspond to 95% and 94% trapping of total COVS (approximately 1300 ppm upstream) and remain high after 4 hours of cooking. Replacing the activated carbon NGR1T W35 by DARCO K B-G induces a slight decrease in the long-term trapping efficiency which remains equal to 91%.

### Application Example 10: Fryer Lid

Fryers are food cooking appliances which generate unpleasant fried odors during their operation.

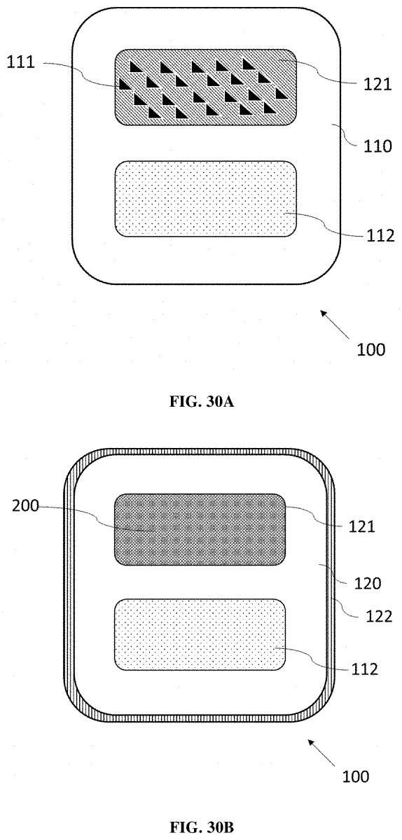

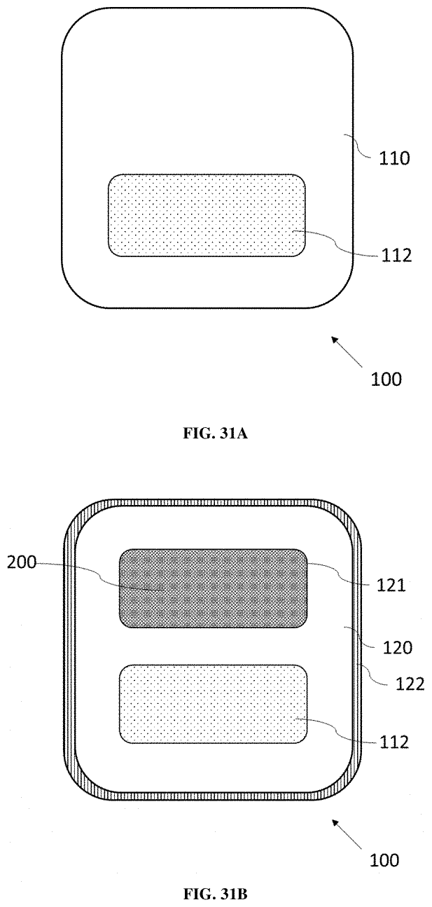

The Applicant has developed an anti-odor cover making it possible to limit and/or prevent the escape of frying odors from the fryer. Two embodiments are presented in FIGS. 30A & 30B, and 31A & 31 B.

For this, the Applicant has integrated one of the materials of the invention comprising core-shell particles with an activated carbon core coated with a layer of sol-gel silica, functionalized or not, in a filter cartridge. This is arranged in the housing 121 of the lower wall 12 of the cover 1 so that during cooking, the frying vapors are trapped in the core-shell nanoparticles of the invention.

1-21. (canceled)

22. An anti-odor cover comprising an upper wall and a lower wall wherein the anti-odor cover comprises a filter material including core-shell particles comprising or consisting of activated carbon core surrounded by a shell of sol-gel silica, preferably mesoporous.

23. The anti-odor cover according to claim 22, comprising a shape suitable for closing a cooking appliance, said lower wall being directed towards the interior of the cooking appliance.

24. The anti-odor cover according to claim 22, wherein the lower wall comprises a housing adapted to receive the filter material or a filter system comprising said filter material.

25. The anti-odor cover according to claim 24, wherein the housing is arranged between the upper wall and the lower wall.

26. The anti-odor cover according to claim 24, wherein the housing comprises the filter material on the side of the lower wall and comprises at least one exhaust opening on the side of the upper wall, in order to allow the passage of a flow of vapor through the anti-odor cover.

27. The anti-odor cover according to claim 22, wherein the core-shell particles are spherical and have a diameter of 20 to 400 nm.

28. The anti-odor cover according to claim 22, wherein the mesoporous sol-gel silica shell comprises a siloxane formed from at least one organosilicate precursor selected from tetramethoxysilane (TMIOS), tetraethoxysilane (TEOS), phenyltrimethoxysilane (PhTMOS), phenyltriethoxysilane (PhTEOS), (2-phenylethyl)triethoxysilane, 3-aminopropyltriethoxysilane (APTES), (3-glycidyloxypropyloxy)trimethoxysilane (GPTMOS), (3-glycidyloxypropyl)triethyoxysilane (GPTES), N-(2-aminoethyl)-3-(trimethoxysilyl)propylamine (NH₂-TMOS), N-(trimethoxysilylpropyl) ethylenediaminetriacetate, acetoxyethytrimethoxysilane (AETMS) 1′ureidopropyltriethoxysilane (UPTS), 3-(4-semicarbazidyl) propyltriethoxysilane (SCPTS) and mixtures thereof; preferably the organosilicon precursor is tetramethoxysilane or tetraethoxysilane.

29. The anti-odor cover according to claim 22, in which the organosilicate precursor is a mixture of tetramethoxysilane and a functionalized organosilicate precursor, advantageously chosen from phenyltrimethoxysilane (PhTMOS), phenyltriethoxysilane (PhTEOS), (2-phenylethyljtriethoxysilane, 3-aminopropyltriethoxysilane (APTES), (3-glycidyloxypropyijtrimethoxysilane (GPTMOS), (3-glycidyloxypropyl)triethoxysilane (GPTES), N-(2-Aminoethyl)-3-(trimethoxysilyl)propylamine (NH₂-TMOS), the N-(Trimethoxysylpropyl) ethylenediaminetriacetate, acetoxyethyltrimethoxysilane (AETMS), ureidopropyltriethoxysilane (UPTS), 3-(4-semicarbazidyl) propyltriethoxysilane (SCPTS) and mixtures thereof.

30. The anti-odor cover according to claim 22, wherein the activated carbon is in the form of sticks of millimeter size.

31. The anti-odor cover according to claim 22, further comprising a window.

32. The anti-odor cover according to claim 22, further comprising an annular seal.

33. A food cooking appliance comprising an anti-odor cover according to claim 22.

34. The food cooking appliance according to claim 33, comprising a cooking bath tank; preferably the food cooking appliance is a fryer.

35. A filter cartridge for an anti-odor cover, comprising a filter material including core-shell particles comprising or consisting of a core of activated carbon surrounded by a shell of silica sol-gel, preferably mesoporous.

36. The filter cartridge for an anti-odor cover according to claim 35, wherein the core-shell particles are spherical and have a diameter of 20 to 400 nm.

37. The filter cartridge for an anti-odor cover according to claim 35, wherein the mesoporous sol-gel silica shell comprises a siloxane formed from at least one organosilicon precursor selected from tetramethoxysilane (TMIOS), tetraethoxysilane (TEOS), phenyltrimethoxysilane (PhTMOS), phenyltriethoxysilane (PhTEOS), (2-phenylethyl) triethoxysilane, 3-aminopropyltriethoxysilane (APTES), (3-glycidyloxypropyl)trimethoxysilane (GPTMOS), (3-glycidyloxypropyl)triethoxysilane (GPTES), N-(2-aminoethyl)-3-(trimethoxysilyl)propylamine (NH₂-TMOS), N-(trimethoxysilylpropyl) ethylenediaminetriacetate, acetoxyethyltrimethoxysilane (AETMS), ureidopropyltriethoxysilane (UPTS), 3-(4-semicarbazidyl) propyltriethoxysilane (SCPTS) and mixtures thereof; preferably the organosilicon precursor is tetramethoxysilane or tetraethoxysilane.

38. The filter cartridge for an anti-odor cover according to claim 35, wherein the organosilicon precursor is a mixture of tetramethoxysilane and a functionalized organosilicon precursor, advantageously selected from phenyltrimethoxysilane (PhTMOS), phenyltriethoxysilane (PhTEOS), (2-phenylethyl) triethoxysilane, 3 aminopropyltriethoxysilane (APTES), (3-glycidyloxypropyl) trimethoxysilane (GPTMOS), (3-glycidyloxypropyl)triethoxysilane) (GPTES), N-(2-aminoethyl)-3-(trimethoxysilyl)propylamine (NH₂-TMOS), N-(Trimethoxysilylpropyl)ethylenediaminetriacetate, acetoxyethyltrimethoxysilane (AETMS), ureidopropyltriethoxysilane (UPTS), 3-(4-semicarbazidyl)propyltriethoxysilane (SCPTS) and mixtures thereof.

39. The filter cartridge for an anti-odor cover according to claim 35, wherein the activated carbon is in the form of millimeter sized sticks.
